(19) United States
(12) Patent Application Publication
(10) Pub. No.: US 2013/0146459 A1
(43) Pub. Date: Jun. 13, 2013

(54) MULTIPHASE NON-LINEAR ELECTROKINETIC DEVICES

(71) Applicants: Martin Bazant, Wellesley, MA (US); Manu Prakash, Cambridge, MA (US)

(72) Inventors: Martin Bazant, Wellesley, MA (US); Manu Prakash, Cambridge, MA (US)

(73) Assignee: MASSACHUSETTS INSTITUTE OF TECHNOLOGY, CAMBRIDGE, MA (US)

(21) Appl. No.: 13/120,744

(22) PCT Filed: Jun. 15, 2010
(86) PCT No.: PCT/US10/38609

§ 371 Date: Feb. 25, 2013

Related U.S. Application Data
(60) Provisional application No. 61/187,462, filed on Jun. 16, 2009.

(51) Int. Cl. G01N 27/447

(52) U.S. Cl. CPC G01N 27/447
USPC 204/454; 204/451; 204/601

(57) ABSTRACT

This invention provides devices and apparatuses comprising the same and methods of use thereof for efficient pumping and/or mixing of relatively small volumes of fluid, wherein the fluid contains a sample within an inner fluid phase dispersed in an outer phase. Such devices utilize nonlinear electrokinetics as a primary mechanism for driving fluid flow and/or mixing the fluid. Methods of cellular analysis, drug delivery and others, utilizing the devices are described.

### BACKGROUND OF THE INVENTION

“Induced-charge electro-osmosis” (ICEO) refers to the nonlinear electrokinetic phenomenon of fluid flow past a polarizable surface due to an applied voltage, where an electric field acts on its own induced-charge in solution around the surface. In the simplest case, ICEO flow occurs around a metal or dielectric surface in response to an electric field applied at a distant background electrodes. If the surface is a conductor whose potential is controlled externally with respect to the applied voltage at the background electrodes, then “fixed-potential ICEO” flow occurs, which depends on the applied field and the locally applied potential. If the surface is an electrode applying an alternating current (AC), or oscillating voltage, which is the primary source of the electric field, then ICEO flow occurs over the electrode surface itself and is called “AC electro-osmosis” (ACEO).

A wide variety of microfluidic devices have been invented to exploit ICEO flows for pumping and mixing fluids and manipulating colloidal particles or biological cells.

ICEO microfluidic devices have many attractive features, such as (i) fast flows which can exceed mm/sec in dilute electrolytes, (i) low operating voltages, typically <5V, (ii) low power consumption, typically <1 mW, (iii) alternating currents, in some cases up to 100 kHz, which reduce or eliminate Faradaic reactions and related gas bubbles, sample contamination, and electrode deterioration, (iv) no moving parts, (v) programmable local flow control, down to the micron scale in space and down to the millisecond scale in time, (vi) easy integration with standard electronics for control, logic, and communication, (vi) cheap and efficient fabrication using methods from the MEMS, microfluidic, and computer industries. These properties could find many useful applications in microfluidic systems, especially in portable or implantable microfluidic devices.

The applicability of current ICEO microfluidic devices, however, is limited by their sensitivity to the solution chemistry, which is not yet well understood on a theoretical level. It is well known in the art that ICEO flows are rather strong in water or in dilute aqueous electrolytes, such as KCl, below 1 mM bulk salt concentration, but recent experiments have shown that ICEO flows seem to be generally suppressed above 10 mM salt concentration in common electrolytes. Although this may suffice for some applications, it precludes the direct use of ICEO devices to manipulate biological fluids and buffer solutions, which typically have salt concentrations above 1 M. Instead, ICEO flows have only been achieved with biological solutions after dilution with water by a ratio of at least 10:1 (for slow flow) or much more (for faster flow). Such dilution is impractical or undesirable in most biological applications, since cells or biological molecules, such as DNA, RNA, or proteins, require much higher salt concentrations to mimic physiological conditions and preserve their integrity in a microfluidic device. Sample dilution also unnecessarily reduces assay sensitivity, increases reaction or detection times, enlarges sample volumes, and increases device complexity.

Other nonlinear electrokinetic phenomena have also been used to manipulate fluids and particles. An example of such nonlinear phenomena is AC electrothermal (ACET) flow around asymmetric arrays of planar microelectrodes has been. The basic mechanism is that Joule heating due to an applied field produces gradients in the electrical properties of the fluid, which leads to bulk electrical stresses and fluid flow driven by the field. Compared to ACEO, ACET pumps require higher power and operate at higher frequencies (>100 kHz) and higher voltages (>5 V). Thermal gradients can also be harmful and undesirable for biological samples. Inhomogeneous AC fields have also been employed to apply dielectrophoretic (DEP) forces on polarizable drops in a liquid-liquid system with no channels. Large-scale integration of such a system is difficult since no hydrodynamic effects can be employed and no net pumping of fluids is possible.

In this invention, we provide robust nonlinear electrokinetic microfluidic devices that overcome these limitations using multiphase fluids. In particular, the new devices can operate effectively with biological liquids, while retaining all of the attractive features of ICEO flows listed above.

Multiphase digital microfluidic devices trap the relevant chemical or biological samples inside a fluid drops, bubbles or multiphase emulsions dispersed in another continuous fluid phase. This ensures no sample dispersion and sample loss due to absorption by channel walls. Moreover, the digital nature of the device operation (where fluid drops and bubbles hold a fixed quantity of sample volume) due to use of discrete drops and bubbles allows for screening of a large number of reaction conditions in a parallel high-throughput manner.

Single droplet control is challenging in droplet-based multiphase microfluidic devices and only several schemes including dielectrophoretic forces and all-fluidic hydrodynamic logic has been implemented. The above schemes still require external pressure sources for operation.

The ICEO devices of this invention overcome limitations of current multiphase, pressure-driven digital microfluidic devices by enabling higher-precision single-droplet level control, higher-throughput processing, in an integrated manner, which enables a much smaller, truly portable or implantable device via integrating pumping and control in a single technology.

### SUMMARY OF THE INVENTION

The invention describes, inter alia, the use of certain multiphase fluids in electrokinetic microfluidic devices, where the outer phase, mostly in contact with the surfaces driving flow, is a “pumping fluid”, which exhibits fast, reliable flow, and the inner phase, mostly out of contact with such surfaces and typically in the form of droplets, contains the “sample fluid” of interest, which may be a biological fluid or suspension.

In some embodiments, flow of the pumping fluid (outer phase) and/or manipulation of the sample fluid (inner phase) is achieved by nonlinear electrokinetic phenomena other than ICEO or ACEO, such as ACET or DEP.

In some embodiments this invention provides a method for conducting or circulating a sample within an inner fluid phase dispersed in an outer fluid phase via non-linear electrokinetic flow, said method comprising:

applying at least one fluid to an electrokinetic device,
said electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
   electro-osmotic flows with at least one varied trajectory in a region of said chamber, resulting in mixing of said electrolyte fluid;
   a dominant electroosmotic flow which drives said electrolyte fluid across said chamber;
   or a combination thereof;
said at least one fluid comprising:
   a dispersion of a solid or fluid sample in an outer fluid phase, which outer fluid phase comprises an electrolyte fluid; or
   a first fluid comprising an electrolyte and a second fluid comprising a sample, which second fluid is immiscible in said first fluid, and

applying an electric filed to said chamber in at least a single direction,
whereby upon the application of said electric field, said sample is conducted across said chamber or circulated in said chamber, or a combination thereof.

In some embodiments, upon application of an electric field to said chamber said sample in said second fluid is dispersed in said first fluid.

In some embodiments, operation of said nonlinear electrokinetic device provides for induced-charged electro-osmotic flow in said device, or in some embodiments, for alternating current electro-osmotic flow in said device, or in some embodiments, for alternating current electrothermal flow in said device, or in some embodiments, for dielectrophoresis in said device.

In some embodiments, the multiphase fluid is an emulsion or a double or triple emulsion of the sample fluid in the pumping fluid. In other embodiments it is comprised of poly-disperse vesicles and droplets of the sample fluid in the pumping fluid.

In some embodiments, the pumping fluid is water or a dilute aqueous electrolyte. In other embodiments, the pumping fluid is a concentrated aqueous electrolyte, non-aqueous electrolyte, or ionic liquid, in which ICEO flow is enhanced by the use of high-slip polarizable surfaces.

Devices of the invention include pumps, mixers, switches, traps and sensors for the sample fluid phase with applications in biological and chemical lab-on-a-chip technology. Methods of the invention include protocols of using the devices for transporting, mixing, reacting, sorting, separating, steering, trapping, and releasing the sample fluid phase.

In some embodiments, the sample has a salt concentration of between about 15 mM-10M and in some embodiments, the first fluid phase or outer fluid phase has a salt concentration of between about 0.01 mM-9 mM.

In some embodiments, the arrangement of the electrodes and selective application of at least one electric field applies shear stress to the second fluid, or the sample suspension in the electrolyte fluid.

In some embodiments, the device comprises at least two series of electrodes, which series can be modulated temporally in terms of the timing, strength, or oriented application of an electric field or a combination thereof. In some embodiments, the method further comprises the step of specific sorting of the second fluid, or the sample suspension in the electrolyte fluid to a prescribed region of said chamber. In some embodiments, the method further comprises the step of specific trapping of the second fluid, or the sample suspension in the electrolyte fluid within a prescribed region of the chamber. In some embodiments, the method further comprises the step of specific trapping of the second fluid, or the sample suspension in the electrolyte fluid within a prescribed region of the chamber.

In some embodiments, the device is coupled to an analytical module.

In some embodiments, the invention provides a kit for conducting or circulating a sample within a separate inner fluid phase from that of an outer fluid phase via non-linear electrokinetic flow, said kit comprising:
at least one electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
   electro-osmotic flows with at least one varied trajectory in a region of said chamber, resulting in mixing of said electrolyte fluid;
   a dominant electroosmotic flow which drives said electrolyte fluid across said chamber; or
   a combination thereof;
a dispersion of a solid or fluid sample in an outer fluid phase, which outer fluid phase comprises an electrolyte fluid; or
whereby upon the loading of said dispersion in said chamber and the application of an electric field to said chamber, said sample is conducted across said chamber or agitated in said chamber, or a combination thereof.

In some embodiments, the invention provides a kit for conducting or circulating a sample within a separate inner fluid phase from that of an outer fluid phase via non-linear electrokinetic flow, said kit comprising:
at least one electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
   electro-osmotic flows with at least one varied trajectory in a region of said chamber, resulting in mixing of said electrolyte fluid;
   a dominant electroosmotic flow which drives said electrolyte fluid across said chamber; or
   a combination thereof;
a first fluid comprising an electrolyte; and
a second fluid comprising a sample, which second fluid is immiscible in said first fluid; whereby upon the loading of said first fluid and second fluid in said device and the application of an electric field to said chamber, said sample is conducted across said chamber or agitated in said chamber, or a combination thereof.

In some embodiments, the invention provides a multiphase non-linear electrokinetic device for the concentration of a sample within a separate inner fluid phase from that of an outer fluid phase, which outer fluid phase comprises an electrolyte fluid, said non-linear electrokinetic device comprising:
at least one microfluidic chamber;
at least a first electrolyte fluid inlet for introducing said electrolyte fluid to said chamber, wherein at least a portion of said first electrolyte fluid can access a common passageway in said chamber;
at least a second sample inlet for introducing a sample in a fluid phase to said chamber wherein at least a portion of said sample can access a common passageway in said chamber and said sample is not miscible in said first electrolyte fluid or said sample is suspended in a third fluid if said sample is miscible in said first fluid and said third fluid is not miscible in said first fluid;
a plurality of electrodes proximal to, or positioned on, a surface of said chamber, wherein at least two of said plurality of electrodes are connected to a source providing an electric field in said chamber and said electrodes are arranged so as to produce a dominant electroosmotic flow which drives said electrolyte fluid across said chamber;
wherein said common passageway allows for fluid flow in a direction defined by said electrodes and whereby when said electric field is applied to said chamber, at least a portion of said first electrolyte fluid is introduced into said common passageway and at least a portion of said sample or said sample suspended in said third fluid introduced into said chamber is extruded into said common passageway, thereby concentrating a sample within a separate inner fluid phase from that of an outer fluid phase.

In some embodiments, the invention provides a kit comprising the multiphase device of this invention.

In some embodiments, the kit further comprises:
a first fluid comprising an electrolyte; and
a second fluid comprising a sample, which second fluid is immiscible in said first fluid.

In some embodiments, the kit further comprises:
a first fluid comprising an electrolyte;
a second fluid comprising a sample, which is miscible in said first fluid, and
a third fluid which is immiscible in said first fluid, and
instructions for creating a double emulsion in said first fluid, comprising said sample in a inner phase of said double emulsion.

In some embodiments, the invention provides an electrokinetic device for sorting samples dispersed in an electrolyte fluid, said device comprising at least two microfluidic chambers, in fluid connection with each other; wherein
said first of said at least two microfluidic chambers comprises a plurality of electrodes proximal to, positioned on, or comprising a surface of said chamber representing a first series of electrodes;
said second of said at least two microfluidic chambers comprises a plurality of electrodes proximal to, positioned on, or comprising a surface of said chamber, representing a second series of electrodes;
at least two of said plurality of electrodes in said first series and at least two of said plurality of electrodes in said second series are independently addressably connected to a source providing an electric field in said chamber;
said first series of electrodes are arranged so as to produce a dominant electro-osmotic flow which drives said electrolyte fluid across said first chamber; and
said second series of electrodes are arranged so as to produce a dominant electro-osmotic flow which drives said electrolyte fluid across said second chamber;
   whereby upon the application of an electric field independently via said first series or said second series of electrodes, said sample dispersed in said electrolyte fluid is conducted across said first or said second chamber, thereby sorting said sample.

In some embodiments, the device further comprises a joint region, separating said first and second chamber, which joint region comprises a series of electrodes arranged so as to produce a dominant electro-osmotic flow in a direction that differs from that of said electro-osmotic flow in said first chamber, said second chamber, or a combination thereof.

In some embodiments, the device further comprises at least a third chamber, in fluid connection with said first chamber, said second chamber, or a combination thereof, which third chamber comprises a plurality of electrodes proximal to, positioned on, or comprising a surface of said at least a third chamber, representing at least a third series of electrodes; wherein said third series of electrodes are arranged so as to produce a dominant electroosmotic flow which drives said electrolyte fluid across said at least a third chamber. In some embodiments, the first series of electrodes, the second series of electrodes or a combination thereof are so arranged so as to produce electro-osmotic flows with at least one varied trajectory in a region of the first chamber, the second chamber, or a combination thereof, resulting in mixing of the electrolyte fluid.

In some embodiments, the invention provides a method of sorting samples dispersed in an electrolyte fluid, said method comprising
applying at least a first fluid to an electrokinetic device,
   said at least a first fluid comprising:
      a dispersion of a first and second sample in an outer fluid phase, which outer fluid phase comprises an electrolyte fluid; or
      a first fluid comprising an electrolyte and a second fluid comprising a first and second sample, which second fluid is immiscible in said first fluid, and
   said device comprising at least two microfluidic chambers, in fluid connection with each other; wherein
   said first of said at least two microfluidic chambers comprises a plurality of electrodes proximal to, positioned on, or comprising a surface of said chamber representing a first series of electrodes;
   said second of said at least two microfluidic chambers comprises a plurality of electrodes proximal to, positioned on, or comprising a surface of said chamber, representing a second series of electrodes;
   at least two of said plurality of electrodes in said first series and at least two of said plurality of electrodes in said second series are independently addressably connected to a source providing an electric field in said chamber;
   said first series of electrodes are arranged so as to produce a dominant electro-osmotic flow which drives said electrolyte fluid across said first chamber; and
   said second series of electrodes are arranged so as to produce a dominant electro-osmotic flow which drives said electrolyte fluid across said second chamber;
identifying a parameter of said first or second sample or a combination thereof for sorting the same; and
temporally applying an electric filed to said device in at least a first and second direction, whereby upon the application of said electric field in said first direction, said first sample dispersed in said electrolyte fluid is conducted across said first chamber, and upon application of said electric field in said second direction, said second sample dispersed in said electrolyte fluid is conducted across said second chamber, thereby sorting a first and second sample.

In some embodiments, the invention provides a method of drug delivery, said method comprising:
applying at least one drug-containing fluid to an electrokinetic device,
   said electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
      electro-osmotic flows with at least one varied trajectory in a region of said chamber, resulting in mixing of said electrolyte fluid;
      a dominant electroosmotic flow which drives said electrolyte fluid across said chamber;
      or a combination thereof;
   said at least one drug-containing fluid comprising:
      a dispersion of a drug in an outer fluid phase, which outer fluid phase comprises an electrolyte fluid; or
      a first fluid comprising an electrolyte and a second fluid comprising a drug, which second fluid is immiscible in said first fluid, and
applying an electric filed to said chamber in at least a single direction;
whereby upon the application of said electric field, said dispersed drug is optionally circulated in said chamber and conducted across said chamber and said device further provides for delivery of said drug to a subject.

In some embodiments, the device comprises at least two series of electrodes, which series can be modulated temporally in terms of the timing, strength, or oriented application of an electric field or a combination thereof. In some embodiments, the device further comprises a sensor, which detects exit of single drops, bubbles or suspended drug units from said device. In some embodiments, the method further comprises modulating a rate or timing of said exit to accommodate a desired dosage regimen. In some embodiments, at least a portion of said device is biocompatible and said portion is implanted within a subject and in some embodiments, the portion is a cannula.

In some embodiments, the invention provides a method of cellular analysis comprising the steps of:
a. introducing an cell or sub-cellular component suspension to a first port of a device;
b. introducing a reagent for cellular analysis to said first or to a second port of said device, said device comprising:
   at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
      electro-osmotic flows with at least one varied trajectory in a region of said chamber, resulting in mixing of said electrolyte fluid;
      a dominant electroosmotic flow which drives said electrolyte fluid across said chamber;
      or a combination thereof;
   said cell or sub-cellular component suspension comprising:
      a dispersion of said cell or sub-cellular component in an outer fluid phase, which outer fluid phase comprises an electrolyte fluid; or
      a first fluid comprising an electrolyte and a second fluid comprising a cell or sub-cellular component, which second fluid is immiscible in said first fluid, and whereby upon application of said electric field, electro-osmotic flows with at least one varied trajectory are generated in a region of said chamber, resulting in mixing of said electrolyte fluid; a dominant electroosmotic flow is generated, which drives said electrolyte fluid across said chamber, or a combination thereof; and
c. analyzing at least one parameter affected by contact between said suspension and said reagent.

In some embodiments, the reagent is an antibody, a nucleic acid, an enzyme, a substrate, a ligand, or a combination thereof and in some embodiments, the reagent is coupled to a detectable marker. In some embodiments, the marker is a fluorescent compound and in some embodiments, the device is coupled to a fluorimeter or fluorescent microscope.

The preceding summary provides a simplified introduction to some aspects of the invention, but is not intended to define the scope of the invention.

All publications, patents, and patent applications mentioned herein are hereby incorporated by reference in their entirety as if each individual publication or patent was specifically and individually indicated to be incorporated by reference. In case of a conflict between the specification and an incorporated reference, the specification shall control. Where number ranges are given in this document, endpoints are included within the range. Furthermore, it is to be understood that unless otherwise indicated or otherwise evident from the context and understanding of one of ordinary skill in the art, values that are expressed as ranges can assume any specific value or subrange within the stated ranges, optionally including or excluding either or both endpoints, in different embodiments of the invention, to the tenth of the unit of the lower limit of the range, unless the context clearly dictates otherwise. Where a percentage is recited in reference to a value that intrinsically has units that are whole numbers, any resulting fraction may be rounded to the nearest whole number.

### BRIEF DESCRIPTION OF THE DRAWINGS

In the detailed description which follows, frequent reference will be made to the attached drawings, in which:

FIG. 1 shows examples of the multiphase fluids used in this invention, which can be emulsions (FIG. 1A), double emulsions (FIG. 1B), vesicle suspensions (FIG. 1C), or poly-phase emulsions (FIG. 1D). The figure depicts an embodiment of a rectangular channel 1-30 with ICEO/ACEO pumps on the surface of the channel (1-70). The continuous or pumping fluid (1-10) can be a solution optimized primarily for maximum flow rate at a given applied voltage. The clear regions in the channels depict pumping fluid. The sample fluid (1-20) is the discontinuous phase. Such arrangement facilitates the trapping of the sample of interest in discrete droplets. The droplets can also be comprised of a multi-phase double (1-30) or triple emulsion. Multiple droplets (1-50) can be maintained within a double emulsion (1-40, 1-60), as depicted in FIG. 1C. The dispersed phase can either be non-wetting (forming drops) as in FIG. 1A, FIG. 1B, FIG. 1C, FIG. 1D or wetting (forming slugs) as in FIG. 1E, FIG. 1F.

FIG. 2 illustrates different types of electrode arrays applying AC voltages (side views) to drive ACEO flow: asymmetric planar arrays (FIG. 2A), non-planar, stepped 3D electrode-arrays (FIG. 2B), and 3D arrays with insulating sidewalls and horizontal electrode surfaces in embodied devices of this invention. Hereafter, these embodiments and all other embodiments of ACEO pumps will be represented only schematically in the drawings and referred to as a group in the text as “ACEO pumps”. An example of the true 3D geometry is depicted in FIG. 2(B), with and without pillars on the step geometry. Small pillar or other geometry convolute the flow field further, thus enabling complex flow patterns with net directional pumping. In some embodiments, the same electrode arrays may be used to drive ACET flow of the pumping fluid and/or to apply DEP forces to droplets of the sample fluid.

According to this aspect, and in some embodiments, FIG. 3 shows small 3-10 (FIG. 3A), medium 3-20 (FIG. 3B), and large 3-30 (FIG. 3C) droplets of sample fluid dispersed in pumping fluid 3-40 in a microchannel 3-50 with a nonlinear electrokinetic pump 3-60 along the length of one of its surfaces, driving ACEO (and/or ACET) flow as indicated. Illustrative examples of shear flow around the drops, rotational flows within the drops, and overall translational velocities are also indicated. The device acts on the droplets as both a pump (for transport down the microchannel) and a mixer (by shear flows setup inside the droplets). The size variation is depicted in the figure, where ACEO induced flow is capable of transporting variety of drop sizes. Moreover, for drops larger than the channel width, a very large shear is induced close to the droplet walls (FIG. 3(C)). A stepped ACEO pump 3-60 geometry is depicted at the bottom of the channel.

FIG. 4 shows that shear flow during pumping down a microchannel in an embodiment of a device of this invention can be reduced by placing similar ACEO pumps 4-10 pumping in the same direction on two or more opposite sides of a wide channel 4-20 (in the depth direction) to produce a plug-like flow, which transports droplets with little mixing. Such a scheme also enhances the pumping efficiency, thus allowing fast droplet transport.

FIG. 5 shows how internal droplet mixing during pumping down a microchannel can be controlled and enhanced by chaotic convection in an embodied device of this invention. According to this aspect, and in some embodiments, such control may be effected by placing ACEO pumps non-uniformly along the channel walls (FIG. 5A, 5-10 and 5-20), with spatially varying electrode positions, shapes, spacings, or driving voltage signals, breaking symmetry in the transverse direction with herringbone electrode array patterns 5-30 (FIG. 5B) or with three-dimensional metal structures 5-40 placed on the electrodes 5-50 or micro pillars (FIG. 3C not to scale, pillar height exaggerated visually).

FIG. 6 shows how temporal modulation of two or more ACEO pumps in a microcavity can be used to apply shear flows varying in time and space to achieve fast, chaotic mixing of a confined droplet in embodied devices of this invention. Fast mixing induced by this mechanism reduces the channel length required for mixing inside the drop which is costly as real estate on the chip. FIGS. 6A and 6B show how temporal modulation of engaging ACEO pumps on a first side of the channel 6-10 versus a second side of the channel 6-20 can alter the applied shear flow of a droplet 6-30. FIGS. 6D and 6E demonstrate further modulation, when viewing the channel in three dimensions, whereby ACEO pumps on opposing surfaces and in opposing directions 6-10 versus 6-40 alters the shear flow of a droplet 6-30.

FIG. 7 shows how a droplet can be trapped in a microchannel between two opposing ACEO pumps in an embodied device of this invention. Temporal modulation of the pumps can lead to chaotic mixing of the sample fluid in the droplets while trapped, and using only one pump leads to release of the drop downstream. One embodiment of a device of this invention is depicted having four electrodes 7-10, 7-20, 7-30 and 7-40, respectively (FIG. 7A). FIG. 7A1 depicts all four series of electrodes on, resulting in the trapping of the droplet 7-50 in the middle between the four series, and subject multiple local internal shear flows. FIG. 7A2 depicts 2 of the four series of electrodes being “on” (7-10 and 7-20) resulting in an altered internal flow pattern, as indicated by the arrows. FIG. 7A3 depicts 2 of the four series of electrodes being “on” (7-10 and 7-40) resulting in an altered internal flow pattern, as indicated by the arrows. Such temporal modulation can produce a larger set of internal flow patterns in the drop for even more efficient chaotic mixing, as well as transport in and out of the trap using plug-like flows. FIG. 7B shows a cross-junction geometry where a fluid jet breakup can be induced by ACEO pumps.

FIG. 8 shows an embodiment of a trap/mixer/sorter comprised of a cross junction 8-70 of two microchannels 8-50 and 8-60, respectively, with four ACEO pumps 8-10, 8-20, 8-30 and 8-40 aimed at the junction that can be individually addressed. Thus the trap can be initially loaded from the port labeled “load” 8-80. The droplet can be programmatically trapped at the cross junction 8-70. By switching ON or off the two side channels, and the waste channel, the drop can be sorted into either output channel 1 or 2 8-60, or exited via waste channel marked 3 8-50. Such a generic device geometry allows for programmed trapping and sorting of arbitrary samples in multi-phase flow. The device can make measurements on a sample for an arbitrary programmed amount of time before the sorting decision is made which allows the device to be used for numerous applications independent on type of measurement strategy.

FIG. 9 shows an ACEO pump 9-10 oriented transverse to a primary channel 9-30 used to select individual droplets for sorting into a side channels in an embodied device of this invention. This figure depicts the usage of ACEO pumps for a common sorting operation at a Y junction 9-20. Thus a sorting decision can be made downstream and conveyed at the Y junction, allowing individual drops to be sorted out of large sample 9-40. Because ACEO pumps are capable of generating local flow fields, the precise flow field at a Y junction can be controlled to allow for sorting.

FIG. 10 shows an array of metal posts 10-30 in between one or more pairs of electrodes 10-10, 10-20 applying electric fields, which drive complex, programmable patterns of ICEO flow in which droplets 10-40 undergo random walks while experiencing chaotic internal convection in an embodied device of the invention. Such a device could mix droplets in a confined cavity or could have its mixing effect superimposed on a background flow through the device. Similar effects can be achieved with ICEO flows over metal surface patterns and structures.

FIG. 11 shows an embodied device comprising an array of metal posts 11-10 alternately grounded to two electrodes on opposite sides of a microchannel (11-20 and 11-30, respectively) to drive fixed-potential ICEO flow, in which a droplet 11-40 follows a complex trajectory with internal chaotic mixing.

FIGS. 12A and 12B shows additional embodiments of devices of the invention. According to this aspect, droplets 12-10 trapped/concentrated on a larger electrode 12-20 by ACEO flow bringing them to stagnation points where they are held in place by other local forces, such as dielectrophoresis 12-30 and 12-40, respectively. They can be released by application of a DC bias.

FIG. 13 shows an embodied device of the invention comprising a serpentine ACEO pump producing a single pressure head to drive a standard multiphase microfluidic system. Two or more such pumps 13-10 and 13-20, respectively, acting on reservoirs 13-30 and 13-40, respectively of sample fluid and pumping fluid by pressure or suction from flow of the pumping fluid, can also be used to produce the multiphase fluids of the invention. The device allows for a continuous generation of drops and bubbles 13-50 at various junction geometries using ACEO pumps.

FIG. 14 shows embodied schemes for on-demand drop and bubble generation using ACEO flows. FIG. 14A-14B depict a bubble or a droplet generation scheme whenever the pump is turned ON, resulting in explicit control of timing of generation of a single drop or bubble formation. When the ACEO pump 14-10 is active, sample fluid from a microchannel 14-20 is extruded within the stream of pumping fluid from a microchannel 14-30 and a droplet or bubble 14-50 is formed in the downstream microchannel 14-40. FIG. 14C depicts a similar setup for generating a double emulsion 14-60 controlled by ACEO pumps 14-10 and 14-40 in a consecutive flow-focusing geometry where the fluid flow is controlled locally by ACEO pumps.

FIG. 15 shows another embodied device of a scheme for generation of a pull force by an ACEO pump used to generate a drop or a bubble 15-10 at a flow focusing geometry. FIG. 15A and FIG. 15B depict when the pump is switched ON and OFF resulting in a drop or bubble generation.

FIG. 16 depicts mixing inside a drop 16-50 of polarizable liquid induced by applied AC electric field on an electrode pattern 16-10, 16-20, 16-30 and 16-40, in a microfluidic cavity. The direction of the applied field (represented by the arrows) can be controlled by the geometry of the electrodes, resulting in a chaotic streamlines inducing mixing. FIGS. 16A-16B depict engaging an electric field in the direction of the arrows, which results in polarization of the drop, as indicated, whereas turning off of the applied field results in depolarization of the droplet. Similarly, FIGS. 16C-16D depict engaging of an electric field in a different direction (shown by the arrow orientation), resulting in polarization of the droplet as indicated, wherein turning off the applied field results in depolarization of the droplet.

FIG. 17 shows an embodiment of a pre-concentration device for segregating and concentrating different emulsions via a desired parameter, for example, by size, reporter indication or type. FIG. 17A shows a simple two chamber segregator/concentrator embodied device of the invention. ACEO pumps 17-10, 17-20, 17-30 and 17-40 are oriented such a dominant flow can be induced by individual addressing of one or a series of pumps. For example, switching on pumps 17-10 and 17-40 result in conveyance down the long microchannel 17-50. When pump 17-20 is engaged independently, then droplets at the junction between the proximal joint channel 17-10 and main microchannel 17-50 are conveyed toward the joint microchannel and into the parallel preconcentration channel 17-60. Similarly, when pump 17-40 is engaged, such droplets contained within the preconcentration channel 17-60 will be conveyed via the proximal joint microchannel 17-70 out to the main microchannel 17-50. The FIG. 17B shows another embodied device, where additional side microchannels are incorporated. The principle of operation is similar to that in FIG. 17A, whereby when pump 17-50 is engaged independently, then droplets at the junction between the proximal joint channel 17-150 and main microchannel 17-50 are conveyed toward the joint microchannel and into the second parallel preconcentration channel 17-160. Droplets may be sorted in this manner, for example, three different droplets (17-120, 17-130 and 17-140) may be sorted to the three microchannels (17-60, 17-160 and 17-50, respectively). By tuning the flow rate in individual side channels the final output channel can contain all the different size/types separated by distance. The difference in flow rates in side channels results in spatial segregation of sorted droplets. FIG. 17(B) depicts a large scale implementation of the same pre-concentration scheme depicting multiple concentration units working in parallel to separate a three different species both on size and type, with the device initial and final state.

FIG. 18 depicts a large-scale implementation of a trap/sort device where drops (18-10, 18-20) can be simultaneously trapped and sorted dynamically at the same time, using a large number of ACEO pumps (18-30, 18-40, 18-50, 18-60) implemented in a parallel configuration, in an embodied device of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

The preceding FIGURES illustrate some ways in which the principles of the invention may be implemented, but are not intended to limit the scope of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The invention teaches the use of multiphase fluids in ICEO microfluidic devices to allow the manipulation of a wider range of fluids than in existing single-phase ICEO devices. The key property of said multiphase fluids is that the outer phase, mostly in contact with surfaces driving ICEO flow, herein referred to as the “pumping fluid”, exhibits fast, reliable ICEO flow.

In some embodiments, flow of the pumping fluid (outer phase) and/or manipulation of the sample fluid (inner phase) is achieved by nonlinear electrokinetic phenomena other than ICEO or ACEO, such as ACET or DEP.

In some embodiments this invention provides a method for conducting or circulating a sample within an inner fluid phase dispersed in an outer fluid phase via non-linear electrokinetic flow, said method comprising:

applying at least one fluid to an electrokinetic device,
said electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
   electro-osmotic flows with at least one varied trajectory in a region of said chamber, resulting in mixing of said electrolyte fluid;
   a dominant electroosmotic flow which drives said electrolyte fluid across said chamber;
   or a combination thereof;
said at least one fluid comprising:
   a dispersion of a solid or fluid sample in an outer fluid phase, which outer fluid phase comprises an electrolyte fluid; or
   a first fluid comprising an electrolyte and a second fluid comprising a sample, which second fluid is immiscible in said first fluid, and

applying an electric filed to said chamber in at least a single direction,
whereby upon the application of said electric field, said sample is conducted across said chamber or circulated in said chamber, or a combination thereof.

In one embodiment, the term “a” refers to at least one, which in some embodiments, is one, or in some embodiments two or more, or in some embodiments, pairs of, or in some embodiments, a series of, or in some embodiments, any multiplicity as desired and applicable for the indicated application.

In one embodiment, a “device” or “apparatus” of this invention will comprise at least the elements as described herein. In one embodiment, the devices of this invention comprise at least one microchannel, which may be formed as described herein, or via using other microfabrication means known in the art. In one embodiment, the device may comprise a plurality of channels. In some embodiments, the devices of this invention will comprise a plurality of channels, or microchannels. In one embodiment, the phrase “a plurality of channels” refers to more than two channels, or, in another embodiment, channels patterned according to a desired application, which in some embodiments, refers to channels varying by several orders of magnitude, whether on the scale of tens, hundreds, thousands, etc., as will be appreciated by one skilled in the art.

In some embodiments, the “circulating” or “mixing” capabilities of the methods, devices and apparatuses of this invention may involve some component of the flow over the electrodes impinging on another wall of the channel, resulting in recirculation, which in turn, may not flow in the “dominant” flow direction, yet in some aspects, will not detract from the flow in the dominant direction, since for example, pumping down a long channel may occur concurrent with weak or less transverse or sideways component flow impinging on the side walls to generate some mixing, while pumping down the channel.

In some embodiments, the methods, devices and apparatuses of this invention may circulate fluid in a “closed box” where fluid is injected into the device by any means known in the art, prior to or without conveyance of the fluid in a dominant direction, for example, down a long axis of a microchannel of a device of the invention.

In some embodiments, the term “mixing” refers to fluid in the devices/apparatuses of the invention having at least one varied trajectory. In some embodiments, the devices/apparatuses of the invention promote flow along at least one trajectory that effectively stirs the fluid, circulates the fluid, or a combination thereof.

In one embodiment, the microfluidic device comprises placement of the elements on a substrate, or in another embodiment, the microfluidic chamber is contiguous with the substrate.

In one embodiment, the substrate and/or other components of the device can be made from a wide variety of materials including, but not limited to, silicon, silicon dioxide, silicon nitride, glass and fused silica, gallium arsenide, indium phosphide, III-V materials, PDMS, silicone rubber, aluminum, ceramics, polyimide, quartz, plastics, resins and polymers including polymethylmethacrylate (PMMA), acrylics, polyethylene, polyethylene terepthalate, polycarbonate, polystyrene and other styrene copolymers, polypropylene, polytetrafluoroethylene, superalloys, zircaloy?, steel, gold, silver, copper, tungsten, molybdeumn, tantalum, KOVAR, KEVLAR, KAPTON, MYLAR, teflon, brass, sapphire, other plastics, or other flexible plastics (polyimide), ceramics, etc., or a combination thereof.

In some embodiments, the pumping surface comprises a metal, such as Au, Ag, Zn, Ti, Cu, Pt, or alloys of these metals. In some embodiments, the surface comprises a dielectric material, which in some embodiments is a thin dielectric coating on a metal substrate.

In some embodiments, the pumping surface is a high-slip polarizable (HSP) surface. As used herein, a “high-slip polarizable surface” (or “HSP surface”) means a polarizable surface or coating that (1) exhibits a hydrodynamic slip length that is larger than the typical size of the ions or solvents in the liquid near the surface, or (2) exhibits a hydrodynamic slip length that is larger than or comparable to the width of the charged interfacial double layers on the surface. In some embodiments, the HSP surface is carbon-based, comprised of graphite, graphene platelets, nanotubes and other fullerenes. In other embodiments, the HSP surface is composed of a metal/polymer or a superhydrophobic, conducting composite.

In some embodiments, the devices will comprise at least one bubble trap or at least one gas permeable membrane proximal to a microfluidic channel, which in turn may facilitate filling of such channel with a fluid as described herein.

The substrate may be ground or processed flat. High quality glasses such as high melting borosilicate or fused silicas may be used, in some embodiments, for their UV transmission properties when any of the sample manipulation and/or detection steps require light based technologies. In addition, as outlined herein, portions of the internal and/or external surfaces of the device may be coated with a variety of coatings as needed, to facilitate the manipulation or detection technique performed, to enhance flow, to promote mixing, or combinations thereof.

In one embodiment, the substrate comprises a metal-bilayer. In some embodiments, such substrates comprise adhesive or bonding layers such as titanium or chrome or other appropriate metal, which is patterned or placed between the electrode surface and another component of the device substrate, for example, between a distal gold electrode and an underlying glass or plastic substrate.

In one embodiment, the metal-bilayer is such that a metal is attached directly to an electrode, which comprises, or is attached to another component of the substrate.

In another embodiment, the substrate comprises an adhesive layer between, for example underlying glass or plastic substrate and an electrode such as a polymer, a monolayer, a multilayer, a metal or a metal oxide, comprising iron, molybdenum, copper, vanadium, tin, tungsten, gold, aluminum, tantalum, niobium, titanium, zirconium, nickel, cobalt, silver, chromium or any combination thereof. In another embodiment the substrate comprises electrodes of zinc, gold, copper, magnesium, silver, aluminum, iron, carbon or metal alloys such as zinc, copper, aluminum, magnesium, which may serve as anodes, and alloys of silver, copper, gold as cathodes.

In another embodiment, the substrate comprises electrode couples including, but not limited to, zinc-copper, magnesium-copper, zinc-silver, zinc-gold, magnesium-gold, aluminum-gold, magnesium-silver, magnesium-gold, aluminum-copper, aluminum-silver, copper-silver, iron-copper, iron-silver, iron-conductive carbon, zinc-conductive carbon, copper-conductive carbon, magnesium-conductive carbon, and aluminum-conductive carbon.

In some embodiments, the substrate may be further coated with a dielectric and/or a self-assembled monolayer (SAM), to provide specific functionality to the surface of the device to which the material is applied.

In one embodiment, the term “chambers” “channels” and/or “microchannels” are interchangeable, and refer to a cavity of any size or geometry, which accommodates at least the indicated components and is suitable for the indicated task and/or application.

In some embodiments, the chambers will comprise the same materials as the substrate, or in another embodiment, are comprised of a suitable material which prevents adhesion to the channels, or in another embodiment, are comprised of a material which promotes adhesion of certain material to the channels, or combinations thereof. In some embodiments, such materials may be deposited according to a desired pattern to facilitate a particular application.

In another embodiment, the substrate and/or microchannels of the devices of this invention comprise a material which is functionalized to minimize, reduce or prevent adherence of materials introduced into the device. For example, in one embodiment, the functionalization comprises coating with extracellular matrix protein/s, amino acids, PEG, or PEG functionalized SAM's or is slightly charged to prevent adhesion of cells or cellular material to the surface. In another embodiment, functionalization comprises treatment of a surface to minimize, reduce or prevent background fluorescence. Such functionalization may comprise, for example, inclusion of anti-quenching materials, as are known in the art. In another embodiment, the functionalization may comprise treatment with specific materials to alter flow properties of the material through the device. In another embodiment, such functionalization may be in discrete regions, randomly, or may entirely functionalize an exposed surface of a device of this invention.

In one embodiment, the invention provides for a microchip comprising the devices of this invention. In one embodiment, the microchip may be made of a wide variety of materials and can be configured in a large number of ways, as described and exemplified herein, in some embodiments and other embodiments will be apparent to one of skill in the art.

The composition of the substrate will depend on a variety of factors, including the techniques used to create the device, the use of the device, the composition of the sample, the molecules to be assayed, the type of analysis conducted following assay, the size of internal structures, the placement of electronic components, etc. In some embodiments, the devices of the invention will be sterilizable as well, in some embodiments, this is not required. In some embodiments, the devices are disposable or, in another embodiment, re-usable.

Microfluidic chips used in the methods, kits and devices of this invention may be fabricated using a variety of techniques, including, but not limited to, hot embossing, such as described in H. Becker, et al., Sensors and Materials, 11, 297, (1999), hereby incorporated by reference, molding of elastomers, such as described in D. C. Duffy, et. al., Anal. Chem., 70, 4974, (1998), hereby incorporated by reference, injection molding, LIGA, soft lithography, silicon fabrication and related thin film processing techniques, as known in the art, photolithography and reactive ion etching techniques, as exemplified herein. In one embodiment, glass etching and diffusion bonding of fused silica substrates may be used to prepare microfluidic chips.

In one embodiment, microfabrication technology, or microtechnology or MEMS, applies the tools and processes of semiconductor fabrication to the formation of, for example, physical structures. Microfabrication technology allows one, in one embodiment, to precisely design features (e.g., reservoirs, wells, channels) with dimensions in the range of <1 μm to several centimeters on chips made, in other embodiments, of silicon, glass, or plastics. Such technology may be used to construct the microchannels of the devices of this invention, in one embodiment.

In one embodiment, fabrication of the device may be accomplished as follows: first, a glass substrate is metallized. The choice of metal can be made with respect to a variety of desired design specifications, including resistance to oxidation, compatibility with biological materials, compatibility with substrates, etc. The metallization layer may be deposited in a specific pattern (i.e. through adhesive or shadow-masked metal evaporation or sputtering), in one embodiment, or, in another embodiment, it may be etched subsequent to deposition. Metals can include, but are not limited to gold, copper, silver, platinum, rhodium, chromium, etc. In some embodiments, the substrate may be coated with an initial layer of a thin metal, which promotes adhesion of another metal to the substrate. In some embodiments, metals may also be adhered to the substrate via adhesive. In some embodiments, the substrate is ground flat to promote adhesion. In some embodiments, the substrate is roughened to promote metal adhesion.

According to this aspect of the invention, and in one embodiment, the deposited metal may either be deposited in the final topology (i.e. through a mask) or, in another embodiment, patterned post-deposition. According to the latter embodiment, a variety of methods may be used to create the final pattern, as will be understood by one skilled in the art, including inter-alia, etching and laser ablation. Mechanical forms of removal (milling, etc.) may be used, in other embodiments.

In one embodiment, gold is deposited on chromium and the gold is etched using a photoresist mask and a wet gold etchant. The chromium remains a uniform film, providing electrical connection for subsequent electrodeposition (forming the anode connection). In another embodiment, gold is deposited via electron-beam evaporation onto an adhesion layer of titanium. The gold is patterned using a wet etchant and photoresist mask. The titanium is left undisturbed for subsequent electrodeposition.

In another embodiment, the metal may be patterned prior to deposition. A shadow mask can be utilized in one embodiment. The desired shape is etched or machined through a thin metal pattern or other substrate. The etched substrate is then held parallel to the base substrate and the material is deposited via evaporation or sputtering through the mask onto the substrate. In some embodiments, this method is desirable in that it reduces the number of etch steps.

In another embodiment, the patterned surface is formed by transferring a pre-etched or stamped metal film with adhesive onto the substrate. In one embodiment, the various devices on the layer have a common electrical connection enabling subsequent electrodeposition, and are deposited strategically so that release and dicing results in proper electrical isolation.

In another embodiment, a rigid stamp is used to puncture a thin metal film on a relatively pliable elastic (plastic) substrate. The rigid stamp can have, in some embodiments sharp or blunt edges.

In some embodiments, the thickness of deposited metals is tailored to specific applications. In one embodiment, thin metal is deposited onto the surface of the wafer and patterned. According to this aspect of the invention, and in one embodiment, the patterned surface forms a common anodic connection for electroplating into a mold.

In one embodiment, molding may be used. In one embodiment, molding comprises a variety of plastics, ceramics, or other material which is dissimilar to the base substrate. In one embodiment, the molding material is removed following electroplating. In some embodiments, the molding material is sacrificial.

In another embodiment, thick (greater than a few microns) metal is deposited and subsequently etched to form raised metal features.

In other embodiments, welding, assembly via SAMs, selective oxidation of thin metals (conversion of, for instance, aluminum to aluminum oxide) comprise some of the methods used to form insulating areas and provide electrical isolation.

In other embodiments, passivation of the metal surfaces with dielectric materials may be conducted, including, but not limited to, spin-on-glass, low temperature oxide deposition, plastics, photoresists, and other sputtered, evaporated, or vapor-deposited insulators.

Device geometry can take a variety of shapes and sizes. The background electrodes and/or pumping electrodes can be raised off the base substrate or flat. Background electrodes can, in some embodiments, be integrated into microchannels, microchannel walls, recessed from the conducting channel, as will be appreciated by one skilled in the art.

In some embodiments, devices with multiple electrodes, may comprise electrodes which are all of the same shape, different shapes, different sizes, etc. In some embodiments, the electrodes are fashioned as steps, rounded steps, trapezoids, which are continuous along the y-axis, z-axis, or combinations thereof, or in some embodiments, are discontinuous along the y-axis, z-axis, or combinations thereof.

External circuitry can be used to control electrical connections and/or to fix the voltage/potential of any or all of the electrodes. Background electrode potential can be controlled relative to the pumping element electrodes in magnitude, frequency, and phase lag.

In some embodiments, the total charge on the electrodes can also be controlled. Charge can be controlled relative to the background electrodes in magnitude, frequency, and phase lag, as above.

In some embodiments, additional electrode geometries can include rounded portions, which can be fabricated for instance, by evaporating through a narrow slit, or by wet etching a vertical, electroplated electrode.

In some embodiments, the background electrodes can be arranged in a variety of geometries relative to the pumping electrode. The background electrodes can be parallel to one another and transverse to a background fluid flow, or in other embodiments, they can be parallel to one another and parallel to background fluid flow. In some embodiments, they can have an angle between them, resulting in some electric field gradients, which may enhance fluid mixing.

The electrical connections between electrodes and external circuitry can, in some embodiments, be as simple as planar wires connecting the center posts to the external circuits. The electrical connections can be electroplated, in some embodiments. The electrical connections can be buried beneath an insulating material, in some embodiments.

Driving and control electronics can be manufactured on-chip along with the electrodes, in some embodiments. The driving and control electronics can be a separate electronics module, in some embodiments, an external stand-alone unit or microfabricated electronics. The microfabricated electronics module, in some embodiments, can be wire-bonded to the chip containing the electrodes or can be flip-chip bonded.

Fluidic channels can be fabricated by a variety of means, including soft-lithographic molding of polymers on rigid or semi-rigid molds. Channels can also be fabricated in glass via wet etching, plasma etching or similar means. Channels can be formed in plastics via stamping, hot embossing, or other similar machining processes. The channels can then be bonded to the substrate containing the electrode structures. Alignment marks can be incorporated onto the substrate to facilitate assembly. In some instances, metal surfaces can be exposed on substrate and channels to enable metal-to-metal bonding. Glass-to-glass bonding can be done at elevated temperatures and with applied potential. Plastic-to-glass can be facilitated with cleaning of glass surfaces prior to bonding, or fabrication of the fluidic portion of the device can be accomplished by any means known in the art.

In some embodiments, the devices for use in accordance with the methods of this invention, or as part of the kits of this invention include any appropriate non-linear electrokinetic device, including but not limited to those described in WO201001968, U.S. Pat. No. 7,708,873, U.S. Pat. No. 7,691,244, WO2009061843, WO2007092253, WO06110177, US20070240989, U.S. Pat. No. 7,081,189, US20030164296, U.S. Pat. No. 7,531,072, U.S. Pat. No. 7,063,778, fully incorporated herein by reference in their entirety, and others, as will be appreciated by the skilled artisan.

In some embodiments, the microfluidic channels used in the devices and/or methods of this invention, which convey and/or mix fluid, may be constructed of a material which renders it transparent or semitransparent, in order to image the materials being assayed, or in another embodiment, to ascertain the progress of the assay, etc. In some embodiments, the materials further have low conductivity and high chemical resistance to buffer solutions and/or mild organics. In other embodiments, the material is of a machinable or moldable polymeric material, and may comprise insulators, ceramics, metals or insulator-coated metals. In other embodiments, the channel may be constructed from a polymer material that is resistant to alkaline aqueous solutions and mild organics. In another embodiment, the channel comprises at least one surface which is transparent or semi-transparent, such that, in one embodiment, imaging of the device is possible.

In one embodiment, the inlet, or in another embodiment, the outlet may comprise an area of the substrate in fluidic communication with one or more microfluidic channels, in one embodiment, and/or a sample reservoir, in another embodiment. Inlets and outlets may be fabricated in a wide variety of ways, depending upon, in one embodiment, on the substrate material utilized and/or in another embodiment, the dimensions used. In one embodiment inlets and/or outlets are formed using conventional tubing, which prevents sample leakage, when fluid is applied to the device, under pressure. In one embodiment inlets and/or outlets are formed of a material which withstands application of voltage, even high voltage, to the device. In one embodiment, the inlet may further comprise a means of applying a constant pressure, to generate pressure-driven flow in the device.

The device comprises inlets and outlets in fluid communication with the microfluidic chamber. In one embodiment, the inlet may comprise an area of the microfluidic chip in fluidic communication with one or more channels or chambers. Inlets and outlets may be fabricated in a wide variety of ways, depending on the substrate material of the microfluidic chip and the dimensions used. In one embodiment inlets and/or outlets are formed using conventional tubing, which prevents sample leakage, when fluid is applied to the device.

Inlets/outlets allow access to the chambers to which they are connected for the purpose, in one embodiment, of introducing or, in another embodiment, of removing fluids from the chambers on the microfluidic chip. In one embodiment, inlets allow access to the chamber to which they are connected for the purpose of introducing fluids to the microchamber, from a sample reservoir, or in another embodiment, from a sample stored in a conventional storage means, such as a tube. In another embodiment, the outlet allows access of fluid from the microfluidic chamber which has undergone sorting, according to the methods of this invention. According to this aspect of the invention, the outlet may allow for the removal and storage of the sorted material, or in another embodiment, its conveyance to an analytical module, which in one embodiment, may be coupled thereto.

In some embodiments, a device of this invention may be further integrated with size-based separation devices, or in other embodiments, the microsorter may be integrated with pre-concentration devices, enabling assembly, in some embodiments, of a fully-integrated, multidimensional protein sample preparation device.

In some embodiments, when microfluidic chambers are attached to each other, in the methods and comprising the devices of this invention, the construction may be of modular design, such that specific chambers may be inter-connected to each other, and/or to other modules, such as those for analysis, imaging, etc., and yet contained within a single housing. In another embodiment, the design construction is such that numerous arrays can be so constructed, such that any combination of connections may be achieved at a given time. In some embodiments, a plurality of microfluidic chambers, or chips, are provided within a single housing along with a plurality of power supplies and means for detection and/or analysis. In some embodiments, the individual modules can be replaced without removing or exchanging the remaining modules. Dovetail rails and other mechanical assemblies facilitate the swapping of modules in and out, in some embodiments.

In one embodiment, the devices of this invention comprise pump and/or mix fluids using non-linear electroosmotic flow generated within the device.

The microfluidic devices allow for the creation of electro-osmotic flows with at least one varied trajectory in a region of the chamber, resulting in mixing of said electrolyte fluid; or creation of a dominant electroosmotic flow which drives the electrolyte fluid across the chamber or a combination thereof.

In one embodiment, the devices of this invention comprise electrodes connected to a source providing an electric field in the microchannel, wherein the device comprises two or more parallel or interdigitated electrodes, which when in the presence of electrolyte fluids in the device and application of the field produce electro-osmotic flows so that said electrolyte fluid is driven across the microfluidic channels.

In some embodiments, the term “electrode” is to understood to refer to the metal electrode per se, as well as a substrate onto which such an electrode is affixed, or which comprises the electrode, or is proximal to the electrode.

The electrodes of the devices of this invention will have varied height, in some embodiments, or in other embodiments, will not be co-axial, with regard to Cartesian axes, in more than one dimension. It is to be understood that with reference to varied spatial apportionment of the electrodes, e.g. their height, that such reference is in terms of the vertical placement of the electrode, as well as the electrode placed on an underlying substrate. For example, this invention is to be understood to comprise a chamber comprising a pair of electrodes, wherein the electrodes have a comparable width and depth, however one electrodes height may be 10 micron with another being 40 microns, or with another also being 10 microns, however the electrode is positioned on a substrate of 30 microns in height.

It is to be understood that with reference to variance in height, such reference is to be understood to encompass distance normal or orthogonal to the surface on which the electrodes are placed, or in other embodiments, in the direction orthogonal to the mean plane of the surface while, for example, “horizontal” may refer to a direction coplanar with the mean plane of the surface.

In some embodiments, the arrangement of the electrodes is such so as to promote mixing of the materials in the microchannel, as will be appreciated by one skilled in the art, and as exemplified hereinbelow.

In some embodiments, the geometries of the electrodes are varied so as to promote mixing of the fluid in discrete regions of the channel, and/or conveyance of mixed material.

In some embodiments, the device is so constructed so as to promote mixing in certain channels and conveyance to other channels, which in turn may comprise additional steps, which require mixing, as described herein.

In some embodiments, the devices of this invention facilitate deposition of fluids at a site distal to the microchannels, for further processing, or other manipulations of the conveyed material.

In some embodiments, electroosmosis in the devices of this result in the creation of a dominant flow. The term “dominant flow” refers, in some embodiments, to propulsion of fluid in a desired direction (also referred to as “positive direction”), with minimal, or less propulsion of fluid in an undesired direction (also referred to as “negative direction”). In some embodiments, concurrent propulsion in both positive and negative directions may result in drastically reduced overall flow, which occurs with planar electrodes, which are approximately likewise proportioned in at least two of three dimensions, for example, likewise in terms of height and depth, and varied at most in terms of width, in previous ACEO devices. Devices of this invention are likewise proportioned in at most only one of three dimensions, thus varied in terms of height and depth, of an electrode, or portions thereof. Thus, in some embodiments, electrodes in devices of this invention are likewise proportioned in terms of width, likewise proportioned in terms of their depth, however the height of each electrode, or in some embodiments, the height of portions of each electrode, or in some embodiments, the height of pairs of electrodes, or in some embodiments, the height of portions of electrode pairs are varied. In some embodiments, such height alterations may comprise raised or stepped electrode structures, or lowers or recessed electrode structures in a device to provide vertical differences in the electrode structure.

In some embodiments, the terms “height alterations” or “height variance” or other grammatical forms thereof, refer to differences in height, which exceed by at least 1.5%, or in some embodiments, 3%, or in some embodiments, 5%, or in some embodiments, 7.5%, or in some embodiments, 10%, or more the referenced electrode. For example, a planar electrode pair in an array may vary in height by up to 0.25%, as a result, for example, of different deposition of material forming the electrodes on a surface of a channel in the device. In the devices of this invention, in contrast, height variances between at least two electrodes, or electrode pairs, or series in a given device, will be more pronounced, and not a reflection of undesired variance due to material deposition.

In some embodiments, the term “dominant flow” refers to electroosmotic flows, or flows as a result of application of an electric field in a chamber of the devices of this invention. It is to be understood that a dominant flow may be instituted that is less in magnitude, or varied in direction, for example, than other flows in the device, such as other background flows, pressure-driven flows for applying materials to the device, etc.

In some embodiments, the devices of this invention may cause flows for mixing or controlling flow rate (faster/slower/stopping/starting . . . ) in a channel which also has a stronger more “dominant” background flow (e.g. pressure-driven from elsewhere), where the device's dominant effect is still smaller than the background flow, yet is nonetheless greater in magnitude than similar electroosmotic flows would be with the use of planar electrodes. “Dominant” in reference to flows caused by the devices/apparatuses/methods of this invention may be understood, in some embodiments, to specifically exclude background flow, or non-electroosmotic flow.

In some embodiments, the electrodes and metal structures are all “flat” in the sense that the primary exposed surfaces are co-planar and parallel to at least one surface of the channel, although the electrodes may be arranged at different heights and transverse positions in three-dimensional geometries. In other embodiments, the devices comprise periodic arrays of non-flat, three-dimensional electrodes, with raised and lowered sections (on a single electrode).

In another embodiment, at least one electrode of the plurality of electrodes is not flat. In another embodiment, the plurality of electrodes comprises at least one electrode, which is raised with respect to another electrode. In another embodiment, the plurality of electrodes comprises at least one electrode, which is lowered with respect to another electrode. In another embodiment, the plurality of electrodes comprises at least one electrode having a height, which is proportional to a width of another electrode. In another embodiment, the plurality of electrodes comprises at least one electrode having a height, which varies by about 1% to about 100% of a width of another electrode. In another embodiment, the electrodes are not co-axial, with respect to each other, in any dimension. In another embodiment, the positioning of the electrodes in the microfluidic channel is varied with respect to gaps between the electrodes, spacing of the electrodes, or a combination thereof. In another embodiment, the electrodes are arranged in a symmetric pattern in said microfluidic channel, and in another embodiment, the gaps between the electrodes, the spacing of the electrodes, or a combination thereof is equal.

It is to be understood that any variance as described herein with reference to one electrode versus another in the plurality of the devices/apparatuses of this invention is to be taken to refer to portions of electrodes as well, where variance in shape, width, depth, height reflects such variance within a single electrode, in terms of portions of the electrode, different electrodes in the device and any combination thereof.

In another embodiment, the electrodes are arranged in an asymmetric pattern in the microfluidic channel, and in another embodiment, the gaps between the electrodes, the spacing of the electrodes, or a combination thereof is unequal.

In another embodiment, the electrodes are arranged in a gradient pattern in the microfluidic channel.

The term “gradient”, in some embodiments, refers to an arrangement which has gradual or gradated differences, for example in electrode height, from one terminus of such arrangement to another, or in some embodiments, gradual or gradated differences, for example in electrode width, gradual or gradated differences, for example in electrode depth, gradual or gradated differences, for example in electrode shape, gradual or gradated differences, for example in electrode circumference, gradual or gradated differences, for example in the angle at which each electrode is deposited in an array in a device of the invention, or gradual or gradated differences, in any combination thereof, or any desired parameter of the same. In some embodiments, the term gradual or gradated differences refers to differences, which are based on a pattern, in ascending or descending value, which may be consecutive or non-consecutive.

In some embodiments, the term “gradient” refers to any of parameter with regard to electrode geometry, which may vary by any defined/desired period, for example incrementally, or as a multiple or exponential scale, in one or more directions. For example, the layout (gaps, widths, heights, etc.) of each pair of electrodes in an interdigitated array could be rescaled to get larger (or smaller) with distance along the array in the direction of pumping so that the local pumping flow is slower (or faster).

In some embodiment, the gradient may be a function of the gaps between electrodes, spacing of electrodes, height of electrodes or portions thereof, shapes of electrodes or portions thereof, or a combination thereof.

In some embodiments, electrodes are arranged in a pattern as pairs, or series. In some embodiments, arrangement of electrodes which vary in at least 2 or 3 dimensions, in pairs may be such that when a field is applied, one of the electrodes in the pair promotes fluid conductance in the dominant direction, and one in the undesired direction. In some embodiments, such electrodes may be constructed in particular geometries, as described herein, and as will be appreciated by one skilled in the art, such that fluid conductance in the desired direction, versus undesired direction is optimized. In some embodiments, the reverse is effected, such that certain electrode pairs, in some embodiments, promote greater fluid flow in a non-dominant direction, or in varied trajectories from that of the dominant or desired direction. According to this aspect, and in some embodiments, such electrodes may be positioned in between another electrode pair, which promotes fluid flow in a dominant direction, such that mixing of the fluid is localized to the first electrode pair, which when mixed is then conveyed in a dominant direction by the latter electrode pair. Various permutations of such arrangements to promote mixing and/or conveyance are readily apparent to one skilled in the art.

In some embodiments, the electrodes may be arranged in a series, with varying at least 2 of the 3 dimensions of at least one electrode in a given series. Such series may be odd- or even-in number. In some embodiments, the electrodes in a given series may vary in any way as described herein in terms of electrode geometry, patterning in the device, or a combination thereof, and the devices of this invention may comprise multiple series, which in turn may add to the complexity of the arrays of electrodes and capabilities of the devices of this invention.

In another embodiment, the gaps are between about 1 micron and about 50 microns, and in another embodiment, the electrode widths are between about 0.1 microns and about 50 microns.

In some embodiments, the term “dominant flow” refers to propulsion of fluid in alternating directions, which may be modulated, for example via varying the frequency or strength of the field applied, and/or varying or modulating the electrode heights, or portions thereof, resulting in a net conveyance of fluid in a desired direction at a specific time or condition. In some embodiments, the term “dominant flow” refers, to greater propulsion of fluid in a positive rather than negative direction. In some embodiments, the term “greater propulsion” refers to a net propulsion of 51%, or in another embodiment, 55%, or in another embodiment, 60%, or in another embodiment, 65%, or in another embodiment, 70%, or in another embodiment, 72%, or in another embodiment, 75%, or in another embodiment, 80%, or in another embodiment, 83%, or in another embodiment, 85%, or in another embodiment, 87%, or in another embodiment, 90%, or in another embodiment, 95% of the fluid being conveyed in a device of the invention, in a desired or positive direction. In some embodiments, the term “greater propulsion” reflects propulsion of the amount of fluid conveyed in a desired direction as a function of time, with propulsion being greater in a desired direction, predictably, in comparison to a similarly constructed device comprising electrodes of comparable, as opposed to varied height.

In some embodiments, the term “dominant flow” reflects propulsion of fluid conveyed in a desired direction, wherein such fluid is well mixed during, or prior to conveyance in a net desired direction.

The methods, kits and/or devices of this invention provide for conductance of a fluid across the chamber, wherein the fluid comprises a dispersion of a solid or fluid sample in an outer fluid phase, which outer fluid phase comprises an electrolyte fluid; or a first fluid comprising an electrolyte and a second fluid comprising a sample, which second fluid is immiscible in said first fluid

The fluid comprising the dispersion serving as the outer phase and comprising a sample in an inner phase, or the first fluid in which the second fluid comprising the sample is immiscible may also be referred to herein as the “pumping fluid”.

In some embodiments, the pumping fluid is tap water, distilled water, or deionized water. In other embodiments, the pumping fluid is a dilute aqueous electrolytic solution, such as KCl, NaCl, NaI, MgCl2, KI, CaCl2, CuSO4, ZnSO4, HCl, or any combination these salts.

In other embodiments, the pumping fluid is an non-aqueous salt solution or liquid salt which exhibits fast ICEO flow, in some embodiments due to the use of an HSP surface. In some embodiments, said liquid salt is a room-temperature ionic liquid. In some embodiments, the pumping fluid comprises a hydrophobic liquid salt.

In some embodiments, the pumping fluid is any electrolyte fluid. In one embodiment, the term “electrolyte fluid” refers to a solution, or in another embodiment, a suspension, or, in another embodiment, any liquid which will be conveyed upon the operation of a device of this invention. In one embodiment, such a fluid may comprise a liquid comprising salts or ionic species. In one embodiment, the ionic species may be present, at any concentration, which facilitates conduction through the devices of this invention. In one embodiment, the liquid is an aqueous electrolyte solution with added salt concentration in the range of 0.1 microMolar to 100 milliMolar. In one embodiment, the liquid is water, or in another embodiment, distilled deionized water, which has an ionic concentration ranging from about 10 nM to about 0.1M. In one embodiment, a salt solution, ranging in concentration from about 10 nM to about 0.1M is used. In some embodiments, the pumping fluid has a salt concentration of between about 0.01 mM-9 mM

The inner phase of said multiphase fluids, mostly out of contact with said surfaces, herein referred to as the “sample fluid”, is the fluid of primary interest for the application of the devices. In some embodiments, the sample fluid is a biological fluid, such as whole blood, diluted blood, blood plasma, lymph, semen, saliva or urine. In other embodiments, the sample fluid is a biological buffer solution, such as PBS, containing suspended cells, viruses, bacteria, tissue samples, DNA, RNA, enzymes, antigens, antibodies, or proteins.

In some embodiments, the sample fluid contains ethanol, methanol, or other energy-related fluids, such as those arising in processing bio-fuels.

In some embodiments, the sample fluid contains geological liquids, such as petroleum or products involved in the refining of petroleum.

In some embodiments, the sample fluid is a gas, such as air, methane, ethane, hydrogen, oxygen, or carbon dioxide.

In some embodiments, the sample fluid contains solid objects, such as lyophalized drugs, reagents/products of chemical reactions, clathrate-hydrates, metal nanoparticles, quantum dots, diodes, microchips, etc., suspended in an appropriate liquid such as oil or water.

In some embodiments, the sample fluid may comprise bodily fluids such as, in some embodiments, blood, urine, serum, lymph, saliva, anal and vaginal secretions, perspiration and semen, or in another embodiment, homogenates of solid tissues, as described, such as, for example, liver, spleen, bone marrow, lung, muscle, nervous system tissue, etc., and may be obtained from virtually any organism, including, for example mammals, rodents, bacteria, etc. In some embodiments, the solutions or buffered media may comprise environmental samples such as, for example, materials obtained from air, agricultural, water or soil sources, which are present in a fluid which can be subjected to the methods of this invention. In another embodiment, such samples may be biological warfare agent samples; research samples and may comprise, for example, glycoproteins, biotoxins, purified proteins, etc.

In another embodiment, such fluids may comprise a final electrolyte concentration which ranges from between about 10 nM-10M.

In some embodiments, the device, kits or methods of this invention may further incorporate solutions or buffered media for use suitable for the particular application of the device, for example, with regards to the method of cellular analysis, the buffer will be appropriate for the cells being assayed. In one embodiment, the fluid may comprise a medium in which the sample material is solubilized or suspended. In one embodiment, such a fluid may be a part of the pumping fluid, or in some embodiments, such a fluid may represent a separate fluid applied to the devices/kits of this invention, consistent with certain aspects of the methods described herein.

In one embodiment, the pH, ionic strength, temperature or combination thereof of the media/solution, etc., of any fluid of this invention may be varied, to affect their application, e.g. assay conditions, as described herein, the rate of transit through the device, mixing within the device, or combination thereof.

As will be appreciated by those in the art, virtually any experimental manipulation may have been done on the sample prior to its use in embodiments of the present invention. For example, a variety of manipulations may be performed to generate a liquid sample of sufficient quantity from a raw sample. In some embodiments, gas samples and aerosol samples are so processed to generate a liquid sample containing molecules whose separation may be accomplished according to the methods of this invention.

In some embodiments, the invention provides a kit for conducting or circulating a sample within a separate inner fluid phase from that of an outer fluid phase via non-linear electrokinetic flow, said kit comprising:
at least one electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
   electro-osmotic flows with at least one varied trajectory in a region of said chamber, resulting in mixing of said electrolyte fluid;
   a dominant electroosmotic flow which drives said electrolyte fluid across said chamber; or
   a combination thereof;
a dispersion of a solid or fluid sample in an outer fluid phase, which outer fluid phase comprises an electrolyte fluid; or
   whereby upon the loading of said dispersion in said chamber and the application of an electric field to said chamber, said sample is conducted across said chamber or agitated in said chamber, or a combination thereof.

In some embodiments, the invention provides a kit for conducting or circulating a sample within a separate inner fluid phase from that of an outer fluid phase via non-linear electrokinetic flow, said kit comprising:
at least one electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
   electro-osmotic flows with at least one varied trajectory in a region of said chamber, resulting in mixing of said electrolyte fluid;
   a dominant electroosmotic flow which drives said electrolyte fluid across said chamber; or
   a combination thereof;
a first fluid comprising an electrolyte; and
a second fluid comprising a sample, which second fluid is immiscible in said first fluid;
   whereby upon the loading of said first fluid and second fluid in said device and the application of an electric field to said chamber, said sample is conducted across said chamber or agitated in said chamber, or a combination thereof.

According to this aspect, and in some embodiments, upon the application of an electric field to the chamber, the sample in the second fluid is dispersed in the first fluid.

In another embodiment, according to this aspect, the kit comprises
a first fluid comprising an electrolyte;
a second fluid comprising a sample, which is miscible in said first fluid, and
a third fluid which is immiscible in said first fluid.

In some embodiments, according to this aspect, the kit may further comprise or advises it is for use in conjunction with instructions for creating a double emulsion in the first fluid, comprising the sample in an inner phase of the double emulsion

In other embodiments, this invention provides a kit comprising a device as herein described, including any embodiment thereof, or combination of embodiments described herein, with regard thereto. Such kit may further comprise a first fluid comprising an electrolyte and a second fluid comprising a sample, which second fluid is immiscible in said first fluid, or a dispersion of a solid or fluid sample in an outer fluid phase, which outer fluid phase comprises an electrolyte fluid.

In some embodiments, a kit of this invention may comprise a dispersion, which dispersion comprises an emulsion, or in some embodiments, the dispersion comprises a double emulsion.

In some embodiments, the kit comprises a dispersion comprising the sample contained within a drop or bubble suspended in electrolyte fluid.

In some embodiments, in accordance with the kits of this invention, the sample has a salt concentration of between about 15 mM-10M.

In some embodiments, in accordance with the kits of this invention, the first fluid phase or outer fluid phase has a salt concentration of between about 0.01 mM-9 mM. In some embodiments, in accordance with the kits of this invention, the first fluid phase or outer fluid phase has a salt concentration of between about 0.01 mM-9 mM.

In some embodiments, the kits of this invention may further incorporate a labeling agent, which acts as a reporter for a property or parameter of said sample.

In some embodiments, the devices/kits and/or methods of this invention make use of a dispersion of a solid or fluid sample in an outer fluid phase, which outer fluid phase comprises an electrolyte fluid; or make use of a first fluid comprising an electrolyte and a second fluid comprising a sample, which second fluid is immiscible in said first fluid being applied to a device as described herein, and according to this aspect, and in some embodiments, upon application of an electric field to a chamber of a device of the invention, the sample in the second fluid is dispersed in said first fluid. It will be appreciated that double or triple, etc. emulsions may be similarly prepared and utilized in accordance with the devices/kits and/or methods of this invention.

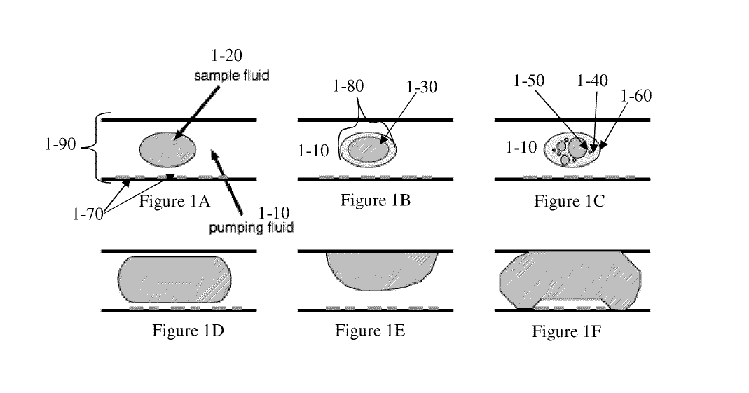

The separation of the sample-fluid phase from the pumping-fluid phase can be accomplished in many ways using standard techniques in the art, as shown in FIG. 1.

For example, if the pumping and sample fluids are immiscible, such as oil and water, then, in some embodiments, the multiphase fluid is an emulsion where droplets of the sample fluid 1-20 are suspended in a continuous phase comprising the pumping fluid 1-10, as shown in FIG. 1A. In some embodiments of this aspect of the invention, said droplets contain oil, as well as optionally drug molecules, enzymes, viruses, cells, proteins, or biological fluids, and the continuous phase contains water or an aqueous electrolyte.

In other embodiments of this aspect, said droplets contain aqueous electrolytes or biological fluids, and said continuous phase is a room-temperature ionic salt.

If the sample fluid and the pumping fluid are miscible, then, in some embodiments, the multiphase fluid is a double emulsion, where the sample fluid 1-30 is encapsulated in a shell of immiscible fluid 1-80 forming droplets in the continuous pumping-fluid phase 1-10, as shown in FIG. 1B. In some embodiments of this aspect, said droplets comprise an aqueous electrolyte or biological fluid encapsulated by oil, and said continuous phase is water or an aqueous electrolyte.

Multiple droplets (1-50) can be maintained within a double emulsion (1-40, 1-60), as depicted in FIG. 1C. The dispersed phase can either be non-wetting (forming drops) as in FIG. 1A, FIG. 1B, FIG. 1C, FIG. 1D or wetting (forming slugs) as in FIG. 1E, FIG. 1F, and the skilled artisan will appreciate that such will be a consequence of the composition of the sample droplets/bubbles/emulsion/dispersion, the composition of the device surfaces, the pumping fluid, or combinations thereof.

In some embodiments, the sample fluid is contained in vesicles encapsulated by lipid bi-layer membranes and suspended in the pumping fluid.

In some embodiments, the interface between the sample fluid and pumping fluid is stabilized using various non-ionic or ionic surfactant molecules, dispersed either in the pumping fluid or in the sample fluid.

In some embodiments, the sample fluid also contains numerous fluorescence or colorimetric tags and molecules for detection.

In some embodiments, droplets of the sample fluid are large enough to occupy large fractions of volume of a microchannel and are separated from the electrodes of polarizable surfaces driving ICEO flow by only a thin lubricating film, as shown in FIG. 1C.

In some embodiments, the sample-fluid phase is in contact with some portions of the walls of the microfluidic, as shown in FIGS. 1D-E, as long as some portion of the electrodes or surfaces driving ICEO flow is in contact with the pumping fluid.

In some embodiments, the drops and bubbles in microfluidic channels can be detected via capacitive measurements from electrodes on the bottom of the channel. This provides an intrinsic feedback in the system that is necessary for complex control operations. Such a detection scheme requires no extra fabrication or manufacturing steps and thus can be implemented in any ICEO (or ACEO) based setup.

In other embodiments, the state of the multiphase fluid, including positions of droplets and bubbles, can be detected by optical means.

In some embodiments, the devices of this invention make use of non-linear, electroosmotic flow to convey and/or mix fluids. In one embodiment, such flow is generated by the elements of the device, and their respective positioning in the device, as exemplified and described herein. Device operation relies upon the evolution of an electric field within the microchannel, which occurs, in some embodiments, as described in U.S. patent application Ser. No. 11/252,871, fully incorporated herein by reference.

In some embodiments, this invention takes advantage of the fact that there is a competition between regions of oppositely directed electro-osmotic slip on the surfaces of interlaced electrodes of opposite polarity, which in turn results in net pumping over the surface. According to this aspect of the invention, by raising the surfaces pumping in the desired direction (and/or lowering those not pumping in the desired direction) one effectively “buries” the reverse convection rolls. If the height difference is comparable to the width of the buried electrodes, the reverse convection rolls turn over near the upper surface and provide an effective “conveyor belt” for the primary pumping flow over the raised electrodes, as further described and exemplified hereinbelow.

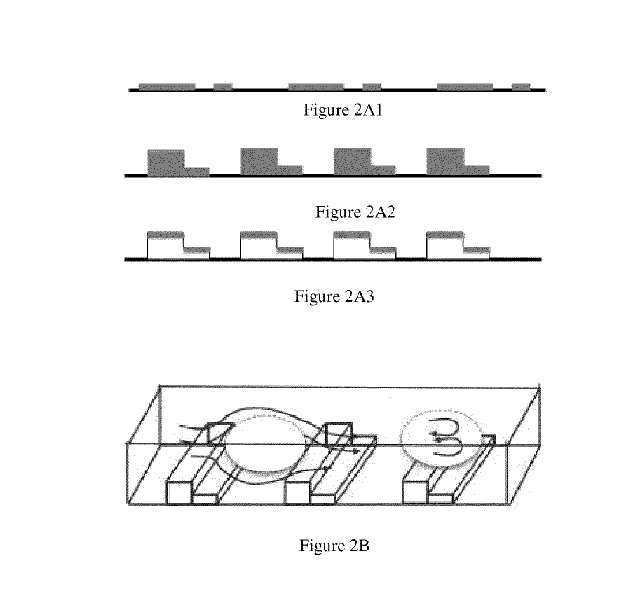

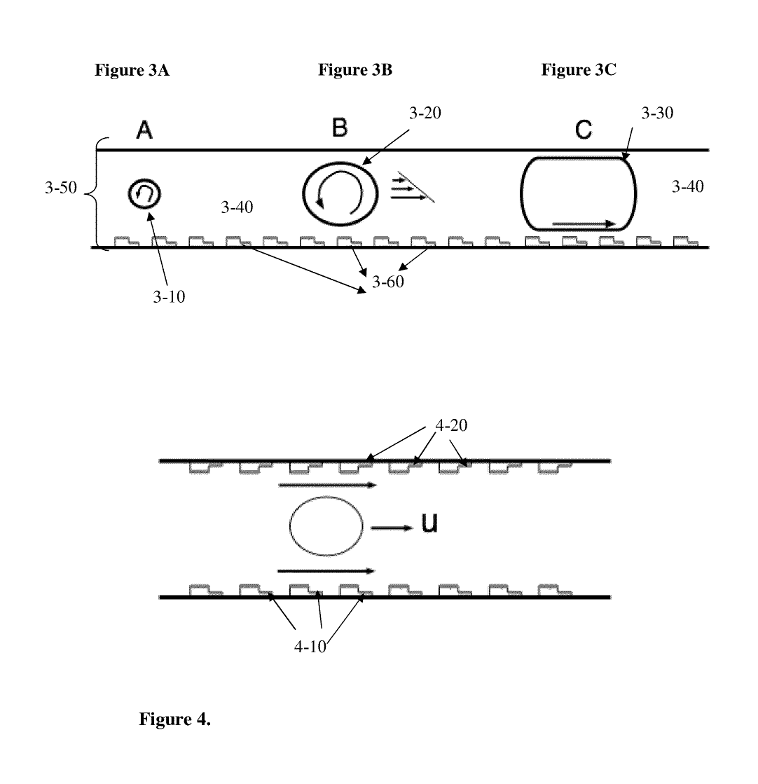

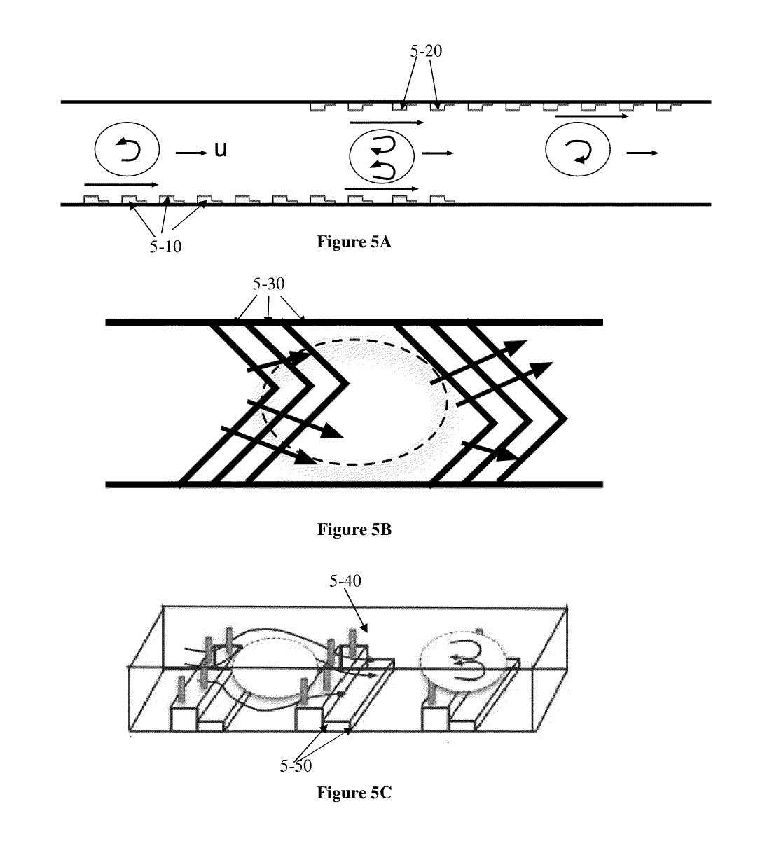

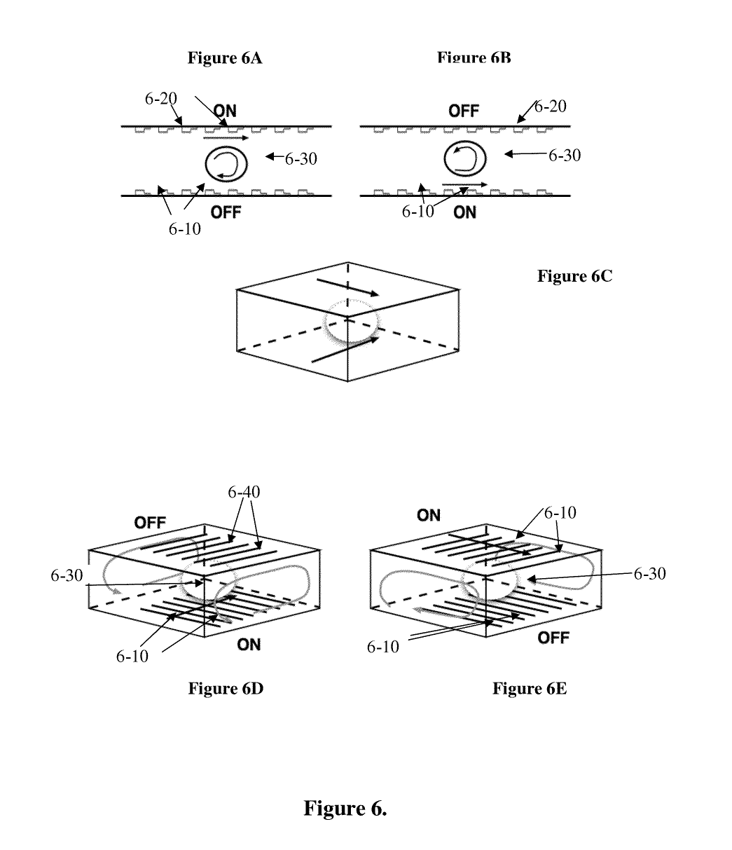

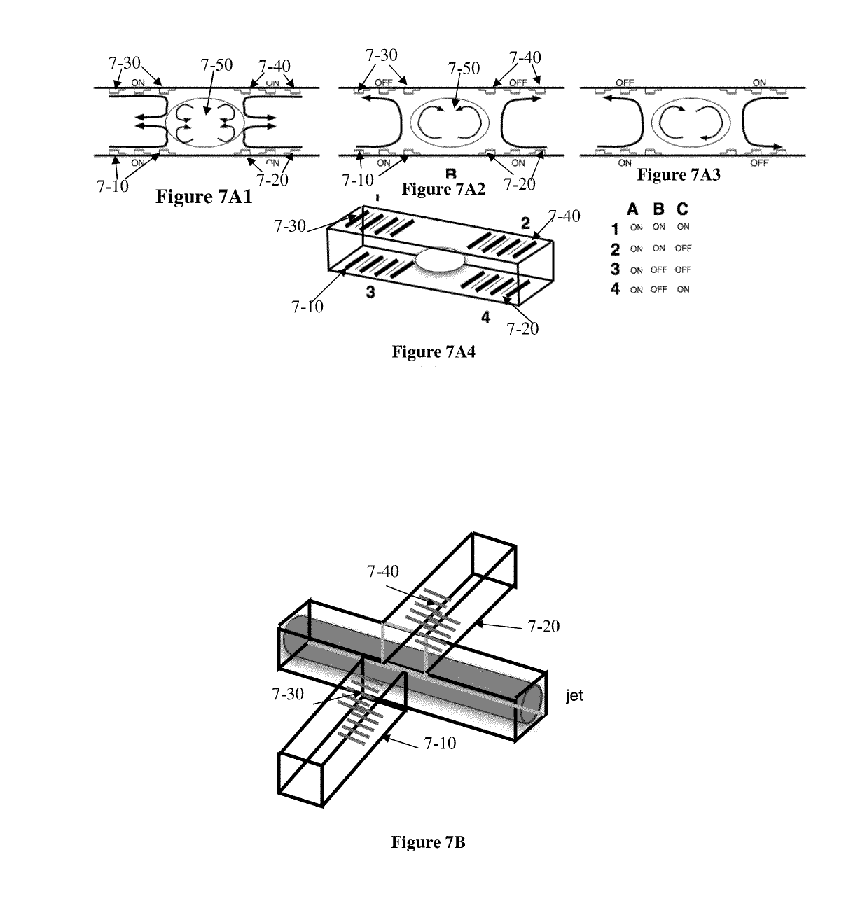

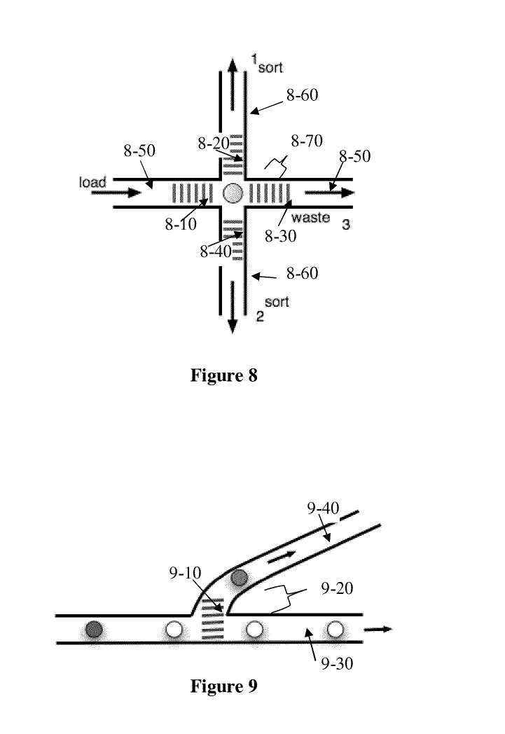

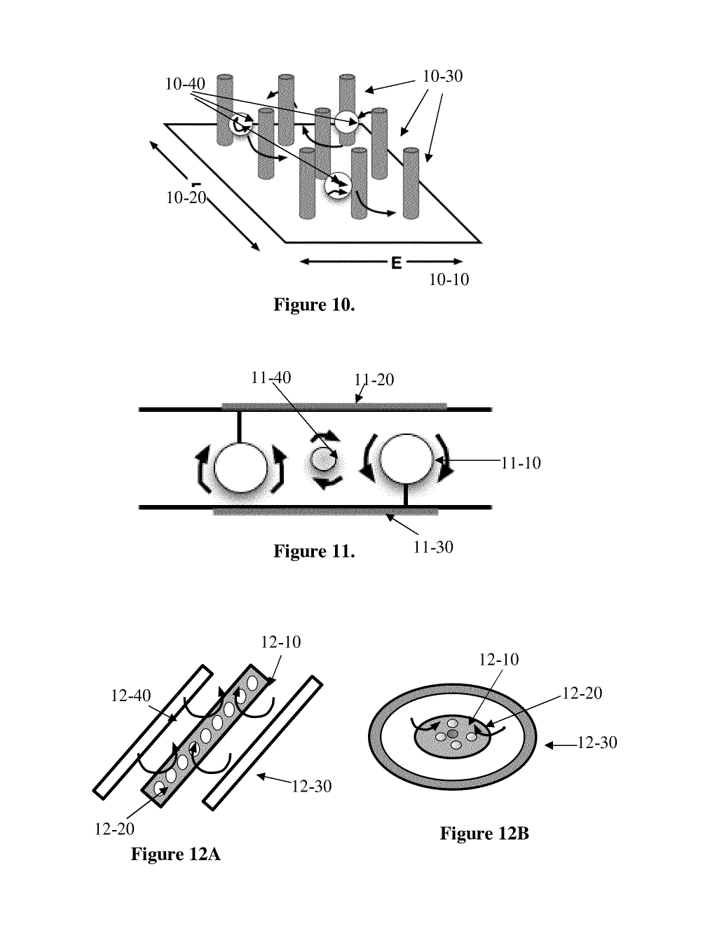

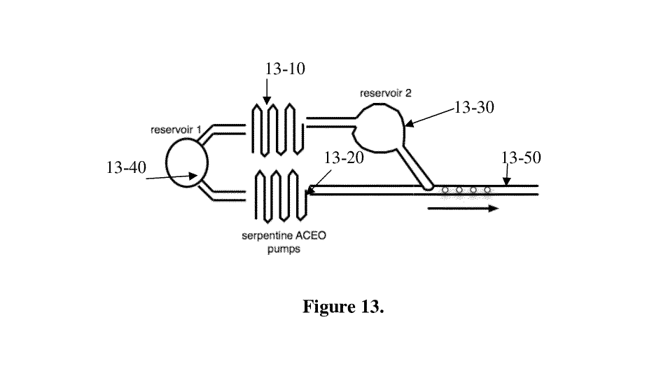

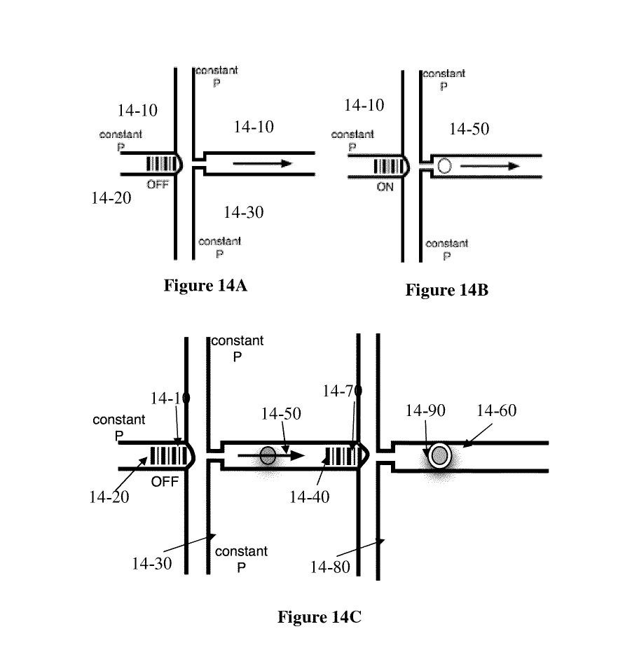

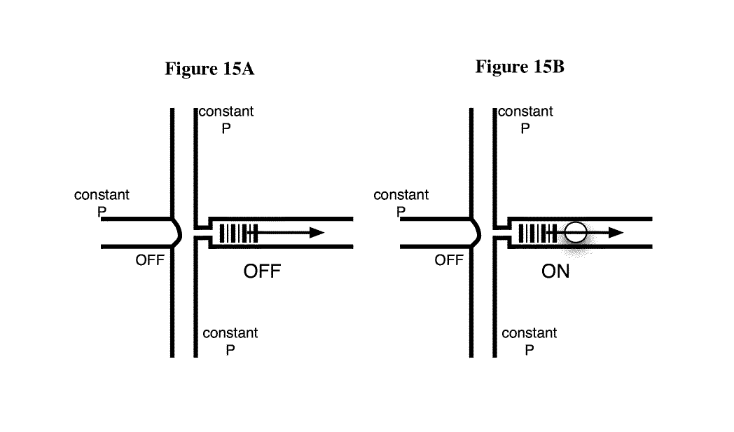

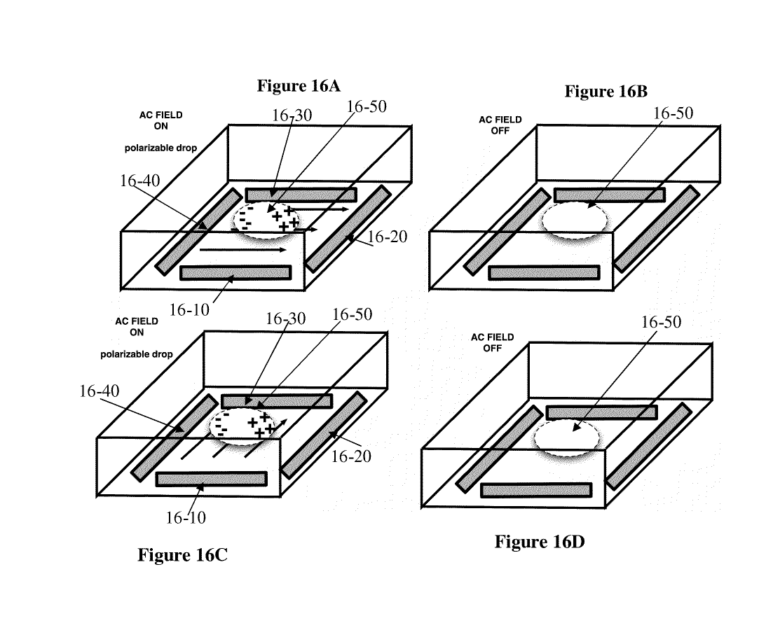

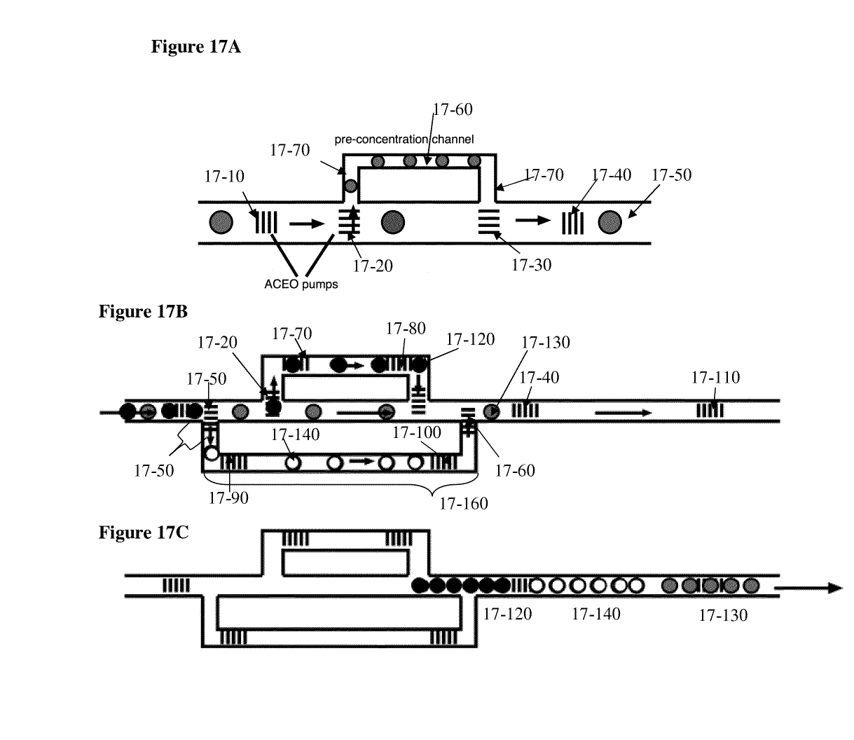

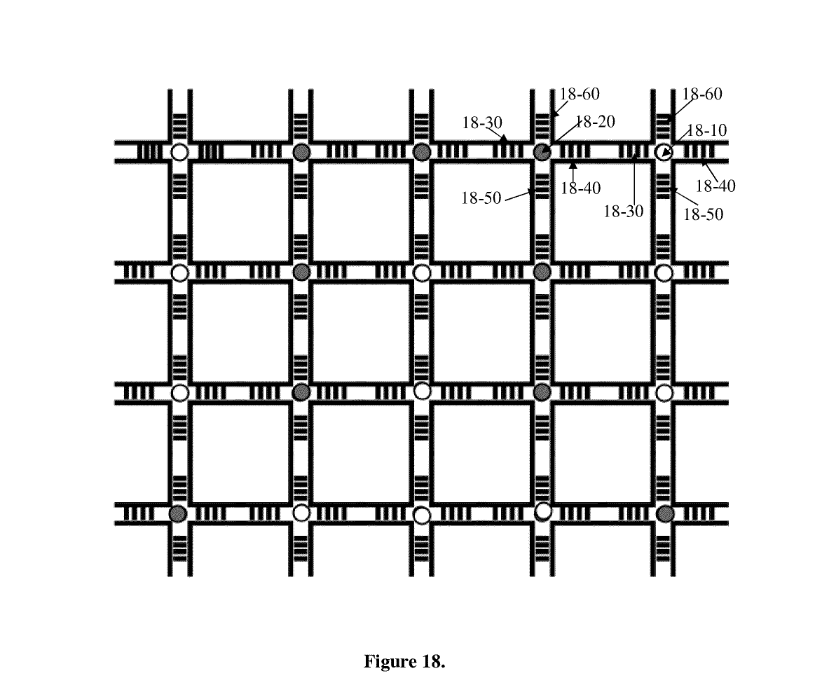

FIG. 2 illustrates different types of electrode arrays applying, in some embodiments, AC voltages to drive ACEO flow: asymmetric planar arrays, non-planar, stepped 3D electrode-arrays, and 3D arrays with insulating sidewalls and horizontal electrode surfaces in embodied devices of this invention. In some embodiments, the same electrode arrays may be used to drive ACET flow of the pumping fluid and/or to apply DEP forces to droplets of the sample fluid.

In some embodiments, the arrangement of the electrodes and selective application of at least one electric field applies shear stress to the second fluid, or the sample suspension in the electrolyte fluid.

According to this aspect, and in some embodiments, FIG. 3 shows small 3-10, medium 3-20 and large 3-30 droplets of sample fluid dispersed in pumping fluid 3-40 in a microchannel 3-50 with a nonlinear electrokinetic pump 3-60 along the length of one of its surfaces, driving ACEO (and/or ACET) flow as indicated. Illustrative examples of shear flow around the drops, rotational flows within the drops, and overall translational velocities are also indicated. The device acts on the droplets as both a pump (for transport down the microchannel) and a mixer (by shear flows setup inside the droplets). The size variation is depicted in the figure, where ACEO induced flow is capable of transporting a variety of drop sizes. FIG. 4 depicts another embodied device of the invention, whereby specific orientation of the pumping elements in a device, or in a particular region of a device will impact shear flow during pumping down a microchannel, for example, by reducing the same, by placing similar ACEO pumps 4-10 pumping in the same direction on two or more opposite sides of a wide channel 4-20 (in the depth direction) to produce a plug-like flow, which transports droplets with little mixing. Such a scheme also enhances the pumping efficiency, thus allowing fast droplet transport.

FIG. 5 shows other embodiments employing this principal of specific placement in terms of location and orientation of pumping elements to regulate net flow and shear flow, with respect to the suspended droplets/bubbles/emultions, etc. According to this aspect, internal droplet mixing during pumping down a microchannel can be controlled, e.g. reduced or enhanced by chaotic convection as a consequence of the placement and orientation of the pumping elements.

According to this aspect, and in some embodiments, such control may be effected by placing ACEO pumps non-uniformly along the channel walls (FIG. 5A, 5-10 and 5-20), including spatially varying the electrode position, shape, spacing, or driving voltage signals, etc., in order to temporally regulate net flow versus chaotic mixing at a specific region in the transit path of the microchannel.

In some embodiments, the pumping element has raised portions of the electrodes that pump in the dominant direction (up to stagnation points on each electrode), by a height varied proportionally to the width of the unraised region.

In some embodiments, the devices of this invention comprise pumping elements comprising raised electrodes, or in other embodiments, raised portions of electrodes, whose height is about proportional to the width of the unraised, recessed or combination thereof electrode, or portion of an electrode. In some embodiments the pumping elements comprising raised electrodes, or in other embodiments, raised portions of electrodes, have a height less than the width of the unraised, recessed or combination thereof electrode, or portion of an electrode. In some embodiments, the term “less than” in this context is by a value of about 1%, or about 5%, or about 8%, or about 10%, or about 15%, or about 17%, or about 20%, or about 25% or about 50%, as compared to the referenced value or parameter (see for Example, U.S. Pat. No. 7,708,873, fully incorporated herein by reference).

In some embodiments, the device comprises at least two series of electrodes, which series can be modulated temporally in terms of the timing, strength, or oriented application of an electric field or a combination thereof. In some embodiments, the method further comprises the step of specific sorting of the second fluid, or the sample suspension in the electrolyte fluid to a prescribed region of said chamber. In some embodiments, the method further comprises the step of specific trapping of the second fluid, or the sample suspension in the electrolyte fluid within a prescribed region of the chamber. In some embodiments, the method further comprises the step of specific trapping of the second fluid, or the sample suspension in the electrolyte fluid within a prescribed region of the chamber.

FIG. 6 schematically depicts an embodiment of the invention, where temporal modulation of two or more ACEO pumps in a microcavity can be used to apply shear flows varying in time and space to achieve fast, chaotic mixing of a confined droplet in embodied devices of this invention. Fast mixing induced by this mechanism reduces the channel length required for mixing inside the drop which is costly as real estate on the chip.

FIG. 7 similarly schematically depicts trapping of a droplet in a microchannel between two opposing ACEO pumps in an embodied device of this invention. Temporal modulation of the pumps can lead to chaotic mixing of the sample fluid in the droplets while trapped, and using only one pump leads to release of the drop downstream. Such temporal modulation can produce a larger set of internal flow patterns in the drop for even more efficient chaotic mixing, as well as transport in and out of the trap using plug-like flows.

In some embodiments, the invention provides a method of sorting samples dispersed in an electrolyte fluid, said method comprising
applying at least a first fluid to an electrokinetic device,
   said at least a first fluid comprising:
   a dispersion of a first and second sample in an outer fluid phase, which outer fluid phase comprises an electrolyte fluid; or
   a first fluid comprising an electrolyte and a second fluid comprising a first and second sample, which second fluid is immiscible in said first fluid, and
   said device comprising at least two microfluidic chambers, in fluid connection with each other; wherein
   said first of said at least two microfluidic chambers comprises a plurality of electrodes proximal to, positioned on, or comprising a surface of said chamber representing a first series of electrodes;
   said second of said at least two microfluidic chambers comprises a plurality of electrodes proximal to, positioned on, or comprising a surface of said chamber, representing a second series of electrodes;
   at least two of said plurality of electrodes in said first series and at least two of said plurality of electrodes in said second series are independently addressably connected to a source providing an electric field in said chamber;
   said first series of electrodes are arranged so as to produce a dominant electro-osmotic flow which drives said electrolyte fluid across said first chamber; and
   said second series of electrodes are arranged so as to produce a dominant electro-osmotic flow which drives said electrolyte fluid across said second chamber;
identifying a parameter of said first or second sample or a combination thereof for sorting the same; and
temporally applying an electric filed to said device in at least a first and second direction,
   whereby upon the application of said electric field in said first direction, said first sample dispersed in said electrolyte fluid is conducted across said first chamber, and upon application of said electric field in said second direction, said second sample dispersed in said electrolyte fluid is conducted across said second chamber, thereby sorting a first and second sample.

FIG. 8-10 show embodiments of embodiments of devices of the invention, where the principle of operation of the same as a means to sort a desired species suspended in pumping fluid can be readily accomplished, for example by trapping such species and then shunting the same to a desired port or location. FIGS. 8 and 9 depict embodied arrangements of pumping elements and microchannel orientation, such that a droplet/bubble/emulsion can be specifically positioned at a desired location on the chip, and in some embodiments, shunted to a specific compartment, e.g. a second channel on the chip. FIG. 10 schematically depicts another embodied aspect of the sorting capability of the kits/devices and methods of sorting in accordance with the description provided herein, wherein an array of metal posts is present in between one or more pairs of electrodes applying electric fields in the device, which drive complex, programmable patterns of ICEO flow in which droplets undergo random walks while experiencing chaotic internal convection. Such a device could mix droplets in a confined cavity or could have its mixing effect superimposed on a background flow through the device. Similar effects can be achieved with ICEO flows over metal surface patterns and structures. In some embodiments, metal posts can be grounded, as depicted in FIG. 11, to arrive at more complex convective flows.

FIG. 12 depicts yet another embodiment of mechanisms whereby a droplet/bubble/emulsion can be specifically trapped in a desired location on a chip or in a channel of a device of this invention, and further whereby such trapped droplet/bubble/emulsion can be released.

FIGS. 13, 14, 15, 17, and 18 schematically depict additional embodiments, whereby a specific droplet/bubble/emulsion or series thereof may be trapped and shunted to a desired location, or in some embodiments, concentrated and then shunted, etc.

In some embodiments, the invention provides an electrokinetic device for sorting samples dispersed in an electrolyte fluid, said device comprising at least two microfluidic chambers, in fluid connection with each other; wherein
said first of said at least two microfluidic chambers comprises a plurality of electrodes proximal to, positioned on, or comprising a surface of said chamber representing a first series of electrodes;
said second of said at least two microfluidic chambers comprises a plurality of electrodes proximal to, positioned on, or comprising a surface of said chamber, representing a second series of electrodes;
at least two of said plurality of electrodes in said first series and at least two of said plurality of electrodes in said second series are independently addressably connected to a source providing an electric field in said chamber;
said first series of electrodes are arranged so as to produce a dominant electro-osmotic flow which drives said electrolyte fluid across said first chamber; and
said second series of electrodes are arranged so as to produce a dominant electro-osmotic flow which drives said electrolyte fluid across said second chamber;
   whereby upon the application of an electric field independently via said first series or said second series of electrodes, said sample dispersed in said electrolyte fluid is conducted across said first or said second chamber, thereby sorting said sample.

In some embodiments, the device further comprises a joint region, separating said first and second chamber, which joint region comprises a series of electrodes arranged so as to produce a dominant electro-osmotic flow in a direction that differs from that of said electro-osmotic flow in said first chamber, said second chamber, or a combination thereof.

In some embodiments, the device further comprises at least a third chamber, in fluid connection with said first chamber, said second chamber, or a combination thereof, which third chamber comprises a plurality of electrodes proximal to, positioned on, or comprising a surface of said at least a third chamber, representing at least a third series of electrodes; wherein said third series of electrodes are arranged so as to produce a dominant electro-osmotic flow which drives said electrolyte fluid across said at least a third chamber. In some embodiments, the first series of electrodes, the second series of electrodes or a combination thereof are so arranged so as to produce electro-osmotic flows with at least one varied trajectory in a region of the first chamber, the second chamber, or a combination thereof, resulting in mixing of the electrolyte fluid.

In one embodiment, the device is adapted such that analysis of a species of interest may be conducted, in one embodiment, in the device, or in another embodiment, downstream of the device. In one embodiment, analysis downstream of the device refers to removal of the obtained product from the device, and placement in an appropriate setting for analysis, or in another embodiment, construction of a conduit from the device, for example, from a collection port, which relays the material to an appropriate setting for analysis. In one embodiment, such analysis may comprise signal acquisition, and in another embodiment, a data processor. In one embodiment, the signal can be a photon, electrical current/impedance measurement or change in measurements. It is to be understood that the devices of this invention may be useful in various analytical systems, including bio-analysis micro-systems, due to the simplicity, performance, robustness, and ability to be integrated to other separation and detection systems and any integration of the device into such a system is to be considered as part of this invention.

In some embodiments, photodiodes, confocal microscopes, CCD cameras, or photomultiplier tubes maybe used to image labels incorporated, and may, in some embodiments, comprise the apparatus of the invention, representing, in some embodiments, a “lab on a chip” mechanism.

In one embodiment, detection is accomplished using laser-induced fluorescence, as known in the art. In some embodiments, the apparatus may further comprise a light source, detector, and other optical components to direct light onto the microfluidic chamber/chip and thereby collect fluorescent radiation thus emitted. The light source may comprise a laser light source, such as, in some embodiments, a laser diode, or in other embodiments, a violet or a red laser diode. In other embodiments, VCSELs, VECSELs, or diode-pumped solid state lasers may be similarly used. In some embodiments, a Brewster's angle laser induced fluorescence detector may used. In some embodiments, one or more beam steering mirrors may be used to direct the beam to a desired location for detection.

In one embodiment, this invention provides an apparatus comprising a device of this invention, which in some embodiments, comprises the analytical modules as described herein.

In some embodiments, the invention provides devices/apparatuses/methods for circulating/mixing a fluid over a target surface with a bound reagent, or in other embodiments, circulates a fluid having a reagent that specifically fluorescently labels analytes that are bound to that surface, which may be assessed via optical means, or in some embodiments, the surface is so constructed so as to detect changes in gate voltage on a transistor structure when an analyte or reagent binds, and when binding creates electrical, conducting, or semiconducting connections between two electrodes on the surface. Such applications may find use in the methods of this invention, as described herein, and as will be appreciated by one skilled in the art.

In some embodiments, this invention provides for analysis, detection, concentration, processing, assay, production of any material in a microfluidic device, whose principle of operation comprises electro-osmotically driven fluid flow, for example, the incorporation of a source providing an electric field in a microchannel of the device, and provision of an electrokinetic means for generating fluid motion whereby interactions between the electric field and induced-charge produce electro-osmotic flows. Such flows may in turn, find application in fluid conductance, mixing of materials, or a combination thereof, and any application which makes use of these principles is to be considered as part of this invention, representing an embodiment thereof. According to this aspect, it is an object of the invention to make use of such electrokinetic devices for the conductance, mixing or combination thereof of a dispersion of a solid or fluid sample in an outer fluid phase, which outer fluid phase comprises an electrolyte fluid; or of a first fluid comprising an electrolyte and a second fluid comprising a sample, which second fluid is immiscible in said first fluid, within such devices, for the specific control of a single droplet/bubbles/emulsion in terms of conductance thereof across a microchannel or chamber of the device, or mixing of the same therein, or a combination thereof.

In one embodiment, the surface of the microchannel may be functionalized to reduce or enhance adsorption of species of interest to the surface of the device. In another embodiment, the surface of the microchannel has been functionalized to enhance or reduce the operation efficiency of the device.

In one embodiment, the device is further modified to contain an active agent in the microchannel, or in another embodiment, the active agent is introduced via an inlet into the device, or in another embodiment, a combination of the two is enacted. For example, and in one embodiment, the microchannel is coated with an enzyme at a region wherein molecules introduced in the inlet will be conveyed past, according to the methods of this invention. According to this aspect, the enzyme, such as, a protease, may come into contact with cellular contents, or a mixture of concentrated proteins, and digest them, which in another embodiment, allows for further assay of the digested species, for example, via introduction of a specific protease into an inlet which conveys the enzyme further downstream in the device, such that essentially digested material is then subjected to the activity of the specific protease. This is but one example, but it is apparent to one skilled in the art that any number of other reagents may be introduced, such as an antibody, nucleic acid probe, additional enzyme, substrate, etc.

In one embodiment, processed sample is conveyed to a separate analytical module. For example, in the protease digested material described hereinabove, the digestion products may, in another embodiment, be conveyed to a peptide analysis module, downstream of the device. The amino acid sequences of the digestion products may be determined and assembled to generate a sequence of the polypeptide. Prior to delivery to a peptide analysis module, the peptide may be conveyed to an interfacing module, which in turn, may perform one or more additional steps of separating, concentrating, and or focusing.

In another embodiment, the microchannel may be coated with a label, which in one embodiment is tagged, in order to identify a particular protein or peptide, or other molecule containing the recognized epitope, which may be a means of sensitive detection of a molecule in a large mixture, present at low concentration.

For example, in some embodiments, reagents may be incorporated in the buffers used in the methods and devices of this invention, to enable chemiluminescence detection. In some embodiments the method of detecting the labeled material includes, but is not limited to, optical absorbance, refractive index, fluorescence, phosphorescence, chemiluminescence, electrochemiluminescence, electrochemical detection, voltametry or conductivity. In some embodiments, detection occurs using laser-induced fluorescence, as is known in the art.

In some embodiments, the labels may include, but are not limited to, fluorescent lanthanide complexes, including those of Europium and Terbium, fluorescein, fluorescamine, rhodamine, tetramethylrhodamine, eosin, erythrosin, coumarin, methyl-coumarins, pyrene, Malacite green, stilbene, Lucifer Yellow, Cascade Blue™, Texas Red, 1,1′-[1,3-propanediylbis[(dimethylimino-3,1-propanediyl]]bis[4-[(3-methyl-2(3H)-benzoxazolylidene)methyl]]-tetraioide, which is sold under the name YOYO-1, Cy and Alexa dyes, and others described in the 9th Edition of the Molecular Probes Handbook by Richard P. Haugland, hereby expressly incorporated by reference. Labels may be added to ‘label’ the desired molecule, prior to introduction into the devices of this invention, in some embodiments, and in some embodiments the label is supplied in a microfluidic chamber. In some embodiments, the labels are attached covalently as is known in the art, or in other embodiments, via non-covalent attachment.

In some embodiments, photodiodes, confocal microscopes, CCD cameras, or photomultiplier tubes maybe used to image the labels thus incorporated, and may, in some embodiments, comprise the apparatus of the invention, representing, in some embodiments, a “lab on a chip” mechanism.

In one embodiment, detection is accomplished using laser-induced fluorescence, as known in the art. In some embodiments, the apparatus may further comprise a light source, detector, and other optical components to direct light onto the microfluidic chamber/chip and thereby collect fluorescent radiation thus emitted. The light source may comprise a laser light source, such as, in some embodiments, a laser diode, or in other embodiments, a violet or a red laser diode. In other embodiments, VCSELs, VECSELs, or diode-pumped solid state lasers may be similarly used. In some embodiments, a Brewster's angle laser induced fluorescence detector may used. In some embodiments, one or more beam steering mirrors may be used to direct the beam to a desired location for detection.

In one embodiment, a solution or buffered medium comprising the molecules for assay are used in the methods and for the devices of this invention. In one embodiment, such solutions or buffered media may comprise natural or synthetic compounds. In another embodiment, the solutions or buffered media may comprise supernatants or culture media, which in one embodiment, are harvested from cells, such as bacterial cultures, or in another embodiment, cultures of engineered cells, wherein in one embodiment, the cells express mutated proteins, or overexpress proteins, or other molecules of interest which may be thus applied. In another embodiment, the solutions or buffered media may comprise lysates or homogenates of cells or tissue, which in one embodiment, may be otherwise manipulated for example, wherein the lysates are subject to filtration, lipase or collagenase, etc., digestion, as will be understood by one skilled in the art. In one embodiment, such processing may be accomplished via introduction of the appropriate reagent into the device, via, coating of a specific channel, in one embodiment, or introduction via an inlet, in another embodiment.

It is to be understood that any complex mixture, comprising two or more molecules, whose assay is desired, may be used for the methods and in the devices of this invention, and represent an embodiment thereof.

It is to be understood that any of the embodiments described herein, with regards to samples, reagents and device embodiments are applicable with regard to any method as described herein, representing embodiments thereof.

In another embodiment, the induced-charge electroosmotic devices of this invention circulate solutions containing probe molecules over target surfaces. In one embodiment, the probe may be any molecule, which specifically interacts with a target molecule, such as, for example, a nucleic acid, an antibody, a ligand, a receptor, etc. In another embodiment, the probe will have a moiety which can be chemically cross-linked with the desired target molecule, with reasonable specificity, as will be appreciated by one skilled in the art. According to this aspect of the invention and in one embodiment, a microchannel of the device may be coated with a mixture, lysate, sample, etc., comprising a target molecule of interest.

In one embodiment, such a device provides an advantage in terms of the time needed for assay, the higher sensitivity of detection, lower concentration of sample/reagents needed, since the sample may be re-circulated over the target surface, or combination thereof.

In some embodiments, in devices for use in regulating drug delivery, the second liquid serves to dilute the drug to a desired concentration. In one embodiment, the device comprises valves, positioned to regulate fluid flow through the device, such as, for example, for regulating fluid flow through the outlet of the device, which in turn prevents depletion from the device, in one embodiment. In another embodiment, the positioning of valves provides an independent means of regulating fluid flow, apart from a relay from signals from the subject, which stimulate fluid flow through the device.

In another embodiment, this invention provides a device for use in drug delivery, wherein the device conveys fluid from a reservoir to an outlet port. In one embodiment, drug delivery according to this aspect of the invention, enables mixing of drug concentrations in the device, or altering the flow of the drug, or combination thereof, or in another embodiment, provides a means of continuous delivery. In one embodiment, such a device may be implanted in a subject, and provide drug delivery in situ. In one embodiment, such a device may be prepared so as to be suitable for transdermal drug delivery, as will be appreciated by one skilled in the art.

In some embodiments, the invention provides a method of drug delivery, said method comprising:

applying at least one drug-containing fluid to an electrokinetic device,
said electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
   electro-osmotic flows with at least one varied trajectory in a region of said chamber, resulting in mixing of said electrolyte fluid;
   a dominant electroosmotic flow which drives said electrolyte fluid across said chamber;
   or a combination thereof;
said at least one drug-containing fluid comprising:
   a dispersion of a drug in an outer fluid phase, which outer fluid phase comprises an electrolyte fluid; or
   a first fluid comprising an electrolyte and a second fluid comprising a drug, which second fluid is immiscible in said first fluid, and

applying an electric filed to said chamber in at least a single direction;

whereby upon the application of said electric field, said dispersed drug is optionally circulated in said chamber and conducted across said chamber and said device further provides for delivery of said drug to a subject.

In some embodiments, according to this aspect, the device comprises at least two series of electrodes, which series can be modulated temporally in terms of the timing, strength, or oriented application of an electric field or a combination thereof. In some embodiments, the device further comprises a sensor, which detects exit of single drops, bubbles or suspended drug units from said device. In some embodiments, the method further comprises modulating a rate or timing of said exit to accommodate a desired dosage regimen. In some embodiments, at least a portion of said device is biocompatible and said portion is implanted within a subject and in some embodiments, the portion is a cannula.

In some embodiments, the geometries of the electrodes are varied so as to promote mixing of the fluid in discrete regions of the channel, and/or conveyance of mixed material.

In some embodiments flat electrode pairs are arranged in an array on or as part of a substrate. In one embodiment in each pair of electrode, the electrodes are of a rectangular shape. In one embodiment in each pair of electrodes, the two rectangular electrodes have the same length and depth, but differ in width. In some embodiment such different in size and in surface area affects the electric field around each electrode, or between two such electrodes.

In some embodiments electrode pairs are of a stepped shape. In one embodiment the electrodes are L-shaped, with one area elevated higher than another area in the electrode. In some embodiment such asymmetric geometry of the electrodes affects the electric field around each electrode, or between two such electrodes.

In some embodiments the two electrodes forming an electrode pair are placed in different height with respect to the underlying substrate. In one embodiment one electrode is placed higher than another electrode. In some embodiment such asymmetric geometry of the electrodes affects the electric field around each electrode, or between two such electrodes. In some embodiment electrodes contain more than one conducting element. In one embodiment the conducting elements are in contact with each other.

In one embodiment an electrode in an electrode pair is made of a planar, rectangular element and a cylindrical element. In one embodiment the cylindrical element is positioned on the planar element and the two elements are in contact. In one embodiment a second electrode in a pair, comprises a similar but narrower planar element and lacks the cylindrical element. In one embodiment such arrangement of an electrode pair breaks the symmetry of the electric field around each electrode and between two electrodes. In some embodiments any geometry and shape of electrodes and any number of contacted conductive elements can be used. In one embodiment electrode elements or parts can be flat, thick, thin, cylindrical, spherical, tear-drop shaped, saw-tooth shaped, zigzagged, wavy, porous, rectangular, square, ball-shaped, triangular, diamond-shaped, star-shaped or any combination thereof.

In some embodiments some electrode parts can be higher than others, deeper, thicker, co-axial, incorporated in, surrounding, placed on top of or overlap with, other parts of the electrodes.

In some embodiments electrodes are placed on one side of a four-sided chamber. In one embodiment the electrodes are placed on two, three or four sides of a four-sided chamber. In one embodiment electrodes are placed around the inner part of a cylindrical chamber or channel. In one embodiment electrodes and electrode arrays forms circles around the inner part of a channel or a chamber. In one embodiment electrodes form a C-shape which overlaps with the inner part of a cylindrical channel. In one embodiment one, two, three, four or any higher number of close to C-shaped or curved electrodes can align a cross section of a cylindrical channel, with gaps between them. In one embodiment four curved electrodes, each with a length that is smaller than a quarter of the circumference of the inner part of a cylindrical channel are placed around a cross-section of an inner part of the cylindrical chamber.

In some embodiment an array of electrodes is placed on the substrate. In one embodiment at least two arrays of electrodes are placed on the substrate. In one embodiment the at least two arrays comprises long rectangular shaped electrodes. In some embodiments the at least two arrays of electrodes are oriented perpendicular to each other with respect to the long axis of the electrodes in each array. In one embodiment perpendicular electrode arrays are placed on the same side of the chamber. In one embodiment the perpendicular arrays are placed on opposite sides of the chamber. In some embodiments perpendicular arrays are placed adjacent to each other.

In some embodiment each array can control fluid flow in a different direction through the modulated application of voltage. In one embodiment, when an electric field is applied to the electrode array, a fluid flow is induced perpendicular to the long axis of the electrodes in the array. In one embodiment this fluid flow is tangential to the substrate on to which the electrodes are fixed. In some embodiments at least two electrode arrays can be operated simultaneously or alternately by applying various electric fields to the arrays. In one embodiment switching the applied electric field in two perpendicular electrode arrays can control, change, orient or modulate the direction of fluid flow in the chamber.

In one embodiment, two electrode arrays are placed on one side of a four-sided chamber. In one embodiment two additional electrode arrays are placed on the opposite side of the four-sided chamber. In one embodiment the electrodes are rectangular. In one embodiment applying an electric field to all four electrode arrays induces four fluid currents next to each array. In one embodiment the four fluid currents cause confinement of liquid portions in four areas adjacent to the four electrode arrays. In some embodiments such confinement can be used to trap particles, solutes, or cells in the fluid. In some embodiments such confinement can be used to pump or mix particles, solutes, or cells in the fluid. In some embodiments turning on and off the electric fields applied to each electrode array in a defined way, changes the kinetics of fluid circulation in the chamber, for example, with regard to regions of the chamber wherein fluid occupying such regions is more rigorously circulated within the region. In one embodiment, one, two, three, four or more fluid-circulating areas can be formed in a channel. In some embodiments the number of fluid circulation areas depends on the number and orientation of the electrode arrays to which electric field is applied.

In one embodiment an array of rectangular electrodes is placed on the inner part of a substrate forming a wall of a chamber. In one embodiment the long axis of the rectangular electrodes is parallel to the long axis of the chamber. In one embodiment the long axis of the electrodes is perpendicular to the long axis of the chamber. In one embodiment when the long axis of the electrode is parallel to the long axis of the channel or chamber, fluid flow is induced perpendicular to the main fluid flow along the channel. In some embodiments such fluid flow caused by applying an electric field to the electrodes, can cause, pumping or mixing of fluid and fluid contents. Such perpendicular fluid flow can slow down the flow in the main flow direction along the channel. Such fluid flow can prolong the time in which particles, solutes or cells spend within the channel or within a special area in the channel. Such perpendicular fluid flow can concentrate a species in a certain area along the channel. Such perpendicular fluid flow can eliminate particles or solutes from certain areas within the channel. Such perpendicular fluid flow can create concentration gradients within the channel. In some embodiments, arrays comprising a large number of electrodes can slow down the progression of a fluid in a more efficient way than arrays comprising smaller number of electrodes

In one embodiment multiple arrays of rectangular electrodes are arranged in a row along the long axis of a microfluidic channel. In one embodiment, the arrays are defined as “A” and “B” arrays. In one embodiment a “B” array is placed after an “A” array along the long axis of the channel. In one embodiment the electrode array arrangement along the long axis of the channel has the pattern of ABABABABA, with respect to the names of the electrode arrays. In one embodiment, “A” and “B” electrode arrays are independently electronically addressed. In one embodiment voltage can be applied to all of the arrays, and in other embodiments voltage can be applied to the “A” arrays or to the “B” arrays only.

In some embodiments, when voltage is appropriately applied to the “A” and “B” arrays, fluid mixing can be achieved. In one embodiment, fluid mixing adjacent to “A” arrays has an opposite fluid flow direction when compared to the fluid flow adjacent to a “B” array. In one embodiment, such mixing can trap or hold or confine particles or solutes in the fluid, to areas adjacent to “A” or “B” arrays.

In one embodiment applying an electric field to the “A” arrays or to the “B” arrays only, can cause fluid flow along alternating directions or opposing directions along the channel. In some embodiments such configuration is used to concentrate species in the fluid, to enhance or reduce chemical reactions between species in a fluid, and to facilitate detection of the fluid content.

In some embodiments, both set of electrodes (“A” and “B”) drive flows in the same direction.

Each set also optionally includes a shifted ‘mirror image’ pattern on the opposite wall of the channel. In that case, when all electrodes are on, there is a uniform plug flow with low hydrodynamic dispersion, which can be used to trap and transport coherent localized volumes of fluid or particles. With temporal modulation of the two sets of electrodes A and B, alternating the strength of pumping by each in time, recirculating flow patterns can be superimposed on the plug flow to cause rapid mixing in the downstream direction. In some embodiments, the modulation time period is comparable to the mean advection time across each individual electrode array to promote chaotic mixing.

In some embodiments, arrays of electrodes are placed on opposite sides of the inner walls of a channel. In one embodiment, two opposing electrode arrays define an area in the channel. In one embodiment, within this area inside the channel, one or more polarizable posts are placed. In one embodiment the polarizable posts affect, divert or change the local electric field. In some embodiments the polarizable posts divert, change or affect the fluid flow direction in the vicinity of the posts. In one embodiment, modulating the voltage of two or more electrode arrays on opposite sides of a microchannel containing one or more polarizable posts, controls the mixing pattern of the fluid in the channel. In one embodiment modulating the AC voltage between an opposing pair of electrodes confining the area of the posts cause mixing driven by induced-charge electro-osmotic flows around the polarizable posts. In some embodiments such flows can also cause transverse pumping due to broken opposing electrode symmetry.

In one embodiment, a device of this invention can be subject to time-modulated AC voltages.

In one embodiment a four-electrode array configuration is used. In some embodiments four electrode arrays or four electrodes are positioned on two sides of a four-sided channel. In one embodiment the electrodes or arrays are referred to as “A”, “B”, “C”, “D”, electrodes, each is placed on one side of the channel. In one embodiment electrodes “A” and “B” are placed on one side and electrodes “C” and “D” are placed on the opposing side. In one embodiment a dominant AC voltage can be applied to “A” and “C” electrodes or to “B” and “D” electrodes. In one embodiment, the dominant AC voltage can switch from being between A and C to B and D. One way to control such switching is to apply an AC voltage to each electrode, A-D, and give each a tunable phase shift relative to the others. In one embodiment, in one state A and B have zero phase shift (same AC voltage) while C and D have a half-period phase shift (same AC voltage, opposite of A and B). In a second state, A and C have zero phase shift, while B and D have a half-period phase shift. By switching between these two (or more) states, rapid chaotic mixing can be achieved in the channel around the posts. In some embodiments, the mixing can be superimposed on a background pressure-driven flow through the post array. In other embodiments, broken symmetry in the geometry of the post array leads to time-modulated pumping through the channel, along with the time-modulated mixing.

In one embodiment, a device of this invention can be subject to time-modulated AC voltages.

In one embodiment a four-electrode array configuration is used. In some embodiments four electrode arrays or four electrodes are positioned on four sides of a four-sided channel. In one embodiment the electrodes or arrays are referred to as “A”, “B”, “C”, “D”, electrodes, each is placed on one side of the channel. In one embodiment electrodes “A” and “C” are placed on opposing sides and electrodes “B” and “D” are placed on opposing sides. In one embodiment, polarizable posts are placed in a microfluidic chamber with at least four electrodes placed on different walls as described above. In one embodiment, such arrangement allows the application of dominant electric fields in orthogonal directions, e.g. left/right using electrodes B and D, or up/down using electrodes A and B. The same sort of time modulation strategies described above can be used to achieve chaotic mixing in the chamber. The switching time should be comparable to the convection time for the dominant fluid vortices amongst the array of posts.

In some embodiments, the device is so constructed so as to promote mixing in certain channels and conveyance to other channels, which in turn may comprise additional steps, which require mixing, as described herein.

In some embodiments, the devices of this invention facilitate deposition of fluids at a site distal to the microchannels, for further processing, or other manipulations of the conveyed material.

In some embodiments, electroosmosis in the devices of this result in the creation of a dominant flow. The term “dominant flow” refers, in some embodiments, to propulsion of fluid in a desired direction (also referred to as “positive direction”), with minimal, or less propulsion of fluid in an undesired direction (also referred to as “negative direction”). In some embodiments, concurrent propulsion in both positive and negative directions may result in drastically reduced overall flow, which occurs with planar electrodes, which are approximately likewise proportioned in at least two of three dimensions, for example, likewise in terms of height and depth, and varied at most in terms of width, in previous ACEO devices. Devices of this invention are likewise proportioned in at most only one of three dimensions, thus varied in terms of height and depth, of an electrode, or portions thereof. Thus, in some embodiments, electrodes in devices of this invention are likewise proportioned in terms of width, likewise proportioned in terms of their depth, however the height of each electrode, or in some embodiments, the height of portions of each electrode, or in some embodiments, the height of pairs of electrodes, or in some embodiments, the height of portions of electrode pairs are varied. In some embodiments, such height alterations may comprise raised or stepped electrode structures, or lowers or recessed electrode structures in a device to provide vertical differences in the electrode structure.

In some embodiments, the terms “height alterations” or “height variance” or other grammatical forms thereof, refer to differences in height, which exceed by at least 1.5%, or in some embodiments, 3%, or in some embodiments, 5%, or in some embodiments, 7.5%, or in some embodiments, 10%, or more the referenced electrode. For example, a planar electrode pair in an array may vary in height by up to 0.25%, as a result, for example, of different deposition of material forming the electrodes on a surface of a channel in the device. In the devices of this invention, in contrast, height variances between at least two electrodes, or electrode pairs, or series in a given device, will be more pronounced, and not a reflection of undesired variance due to material deposition.

In some embodiments, the term “dominant flow” refers to electroosmotic flows, or flows as a result of application of an electric field in a chamber of the devices of this invention. It is to be understood that a dominant flow may be instituted that is less in magnitude, or varied in direction, for example, than other flows in the device, such as other background flows, pressure-driven flows for applying materials to the device, etc.

In some embodiments, the devices of this invention may cause flows for mixing or controlling flow rate (faster/slower/stopping/starting . . . ) in a channel which also has a stronger more “dominant” background flow (e.g. pressure-driven from elsewhere), where the device's dominant effect is still smaller than the background flow, yet is nonetheless greater in magnitude than similar electroosmotic flows would be with the use of planar electrodes. “Dominant” in reference to flows caused by the devices/apparatuses/methods of this invention may be understood, in some embodiments, to specifically exclude background flow, or non-electroosmotic flow.

This invention, in some embodiments, provides for the modulation of such electroosmotic flows, such that chaotic mixing of the fluid is accomplished. In some embodiments, such modulation may result in creating multiple dominant flows, sequentially, as a function of engagement of a particular series of electrodes.

For example, and in some embodiments, two or more series of electrokinetic pumps operating in different directions are turned on and off either at specific intervals, or in some embodiments, at set patterns, or in some embodiments, randomly to mix. The term “series” in some embodiment, refers to positioning and modulation of at least one or a group of electrodes as described herein, such that electroosmotic flows arising upon their engagement are in a comparable or similar direction, or in some embodiments, at a comparable or similar flow rate. In some embodiments, pumps in a series as described herein may encompass pumps located proximally along a Cartesian axis, wherein the electrodes/pumps have at least one surface of such structure abutting a common substrate. In some embodiments, pumps in a series as described herein may encompass pumps located proximally along a Cartesian axis, wherein the electrodes/pumps do not share a common substrate. In some embodiments, a series of pumps may be alternating with another series of pumps, such that for example a first series of pumps results in horizontal fluid flows, whereas the second series results in vertical fluid flows, and such series may alternate, such that overall flow may follow a patter, for example, and in one embodiment, wherein flow is horizontal, then vertical, then horizontal and vertical again.

In some embodiments, the modulation of the voltage is slower than the operating AC frequency of each pump. According to this aspect, and in one embodiment, such control enables each pump the time to generate a quasi-steady flow in its particular direction prior to switching. Similarly, and representing additional embodiments of the invention, modulation of the voltage may be periodic and sinusoidal, at a lower frequency than the typical AC operating frequency of each pump.

In some embodiments, selective application of voltage to a particular series may result in the conveying of the mixed fluid to yet other arrays comprising pumping units so oriented so as to promote further mixing, or in some embodiments, the orientation is to convey the fluid elsewhere within the device structure, or out of the device.

According to this aspect of the invention, each series may be modulated such that the magnitude, frequency or combination thereof of the voltage applied to each series is varied to maximize chaotic mixing. For example, the voltage of series 1 can be lowered to turn it off, while the voltage of series 2 is raised to turn it on. In some embodiments, the frequency of series 1 can be lowered or raised out of the operating range, while the frequency of series 2 is brought into the operating range. It is to be understood that multiple series can be thus modulated, with each series being engaged in any desired pattern or timing, and that reference to 2 alternating series is not to be taken in any way to limit the invention, but rather as an exemplary of how any number of series may be modulated with respect to another in an embodiment of a device of this invention.

It will be appreciated by the skilled artisan that it may be desirable to have smooth transition between engagment of the respective series of electrodes. Such transition can be effected by any number of means, for example via ensuring that the modulating waveform (which provides a sinusoidal envelope for the magnitude of the AC voltage at the operating frequency) is phase shifted by 90 degrees (¼ period) between one pump and the other, so that one is effectively on while the other is off, with the ability to control, in some embodiments, that switching is a smooth transition from one pump to the other, and not sudden.

In some embodiments, the characteristic time scale for switching is comparable to the time for flow to circulate at least halfway around the vortex generated by the pump in the cavity. According to this aspect, and in one embodiment, the switching leads to stretching and folding in the two different pumping directions, which produces chaotic streamlines and very rapid mixing in the same way as the rolling of dough in a bakery.

In some embodiments, the devices/methods of this invention promote chaotic mixing, which in turn results in non-steady time-averaged flow (at the time scale of the applied AC voltage), the latter of which is not very effective for mixing in a fixed volume or cavity of the microfluidic device. In some embodiments, chaotic mixing as a function of the methods/devices of this invention outperform steady flow in a fixed volume, the latter of which mainly reduces the length needed for diffusion from the chamber size to the smallest dimension of the flow structure. Chaotic mixing, as achieved by the methods/devices of this invention, may reduce such length, or time for the flow to reach such structure, etc., as well as provide for active contact between the same.

In some embodiments, electrodes within a series may vary in terms of their height, width, shape, etc. In some embodiments, a series as described herein may be defined by the physical placement of the electrodes within the series, or in another embodiment, by the overall flow of fluid once the electrodes which comprise the series are engaged.

Another embodiment of the device comprises a first series of electrode or electrode-array pumps so arranged such that when engaged, fluid is pumped in the direction of the series of pumps located adjacently on the same substrate, and the second series of pumps, similarly pumps in the direction of its neighbor. A third series of pumps located on a second substrate, however, pumps in a direction opposite to that of the first series of pumps, and the fourth series of pumps. Any number of patterns of engagement of the pumps can be envisioned, which selectively engage a series of pumps in a desired order, to facilitate fluid flow, which results in a desired pattern for mixing fluid contained therein.

Depending upon the desired fluid flow direction, selective engagement of one series can then direct flow to a desired location in the device.

In one embodiment, two or more electrokinetic pumps operating in different directions are turned on and off at specific intervals, or in another embodiment, at set patterns, or in another embodiment, randomly to mix. In another embodiment, two or more electrokinetic pumps pumping in opposing directions are turned on and off either at specific intervals, at set patterns, or randomly to mix.

According to this aspect, and in one embodiment, the devices thus described may result in regions or temporary interruption of flow, as a function of the equal and opposite flow initiated proximal to the oppositely positioned series of electrodes. Such temporary interruption in flow may, in some embodiments serve as a trap and release for material suspended in the flow, for examples, particles in flow, when two pumps are simultaneously engaged and hence fluid flow proximal to each is equal and opposite in direction.

In some embodiments, the devices of this invention include an alternating current electrical controller e.g., which is capable of generating a sine or square wave field, or other oscillating field, which allows for modulation of engagement of a particular series of electrodes, as described herein.

In some embodiments, the devices of this invention include a voltage controller that is capable of applying selectable voltage levels, simultaneously or sequentially, e.g., to a series of electrodes. Such a voltage controller is optionally implemented using multiple voltage dividers and multiple relays to obtain the selectable voltage levels. In some embodiments, multiple independent voltage sources are used. In some embodiments, the voltage controller is as described in U.S. Pat. No. 5,800,690. In some embodiments, modulating voltages affects a desired fluid flow characteristic, e.g., continuous or discontinuous (e.g., a regularly pulsed field causing the sample to oscillate direction of travel), and/or direction of such flow, thereby contributing to chaotic mixing as described herein.

In some embodiments, the devices of this invention provides for induced charge electroosmotic flow over entire arrays of electrodes, and mixing therein, over a large surface area of the chamber of the device.

Devices described here can also be integrated to form very large-scale integrated systems for high throughput screening and manipulation of biological and other samples. Several microfluidic architectures enabling high throughput parallel processing can be employed. One such device can employ parallel channels to perform multiple processing steps in a large number of channels simultaneously. In one embodiment, same signals can be employed in different parallel channels, thus performing the same control steps in different channels only requiring minimum number of control inputs.

In another embodiment, a serial approach can be employed which increases throughput by dividing individual processes into multiple steps all being performed simultaneously on a chip, in different parts of the microfluidic device. This spatial separation of the processing allows for a high-throughput because the sample is being handled continuously and is good for chemical processes requiring a very large number of individual steps.

The invention applies to any use of multiphase fluids in ICEO (or ACEO) microfluidic devices. In what follows, numerous examples are given and methods of their use explained in detail, grouped into several categories, based on the underlying type of ICEO device.

The following recited applications are presented in order to more fully illustrate some embodiments of the invention. They should, in no way be construed, however, as limiting the scope of the invention.

### Applications

The technology in this disclosure allows for integrated control, mixing and pumping of drops and bubbles in multiphase microfluidic systems. Since no external pumping or control elements are required off-chip in the presented scheme, the technology platform provides access to new applications. Some of the applications are briefly described below.

Drug Delivery:

One embodiment of the device can be attached to or implanted in a human or animal body as an autonomous module for controlling delivery of a large number of hormones, bio-molecules, drugs and other agents inside the body in a highly regulated manner. Nonlinear electrokinetic pumps are used to both deliver and digitally control dosage amounts delivered for reagents of interest encapsulated inside droplets in microfluidic channels. Rather than measuring the flow rate, the dosage can be recorded and controlled in real time by digital counting of droplets, e.g. by a simple capacitive sensor in the outlet channel.

In one embodiment, the device or a portion of it, such as cannula, can either be implanted inside the body or in the subcutaneous regions. In another embodiment, the dispersed phase acts as a storage compartment for the reagents of interest and can be phase separated from the continuous phase pumping fluid through a phase-separation porous membrane. In this embodiment, the pumping fluid is never leaked out of the system, and thus need not be replenished over time, allowing long operations of the device with no external control.

In some embodiments, the multiphase fluid is synthesized in the device, e.g. by nonlinear electrokinetic flow through flow focusing nozzle to form a single or double emulsion. In other embodiments, the multiphase fluid is fabricated externally and loaded into the device reservoir for controlled delivery. In that case, the disperse-phase drugs or reagents can be stored in monodisperse droplets or solid capsules, which are themselves formed in other microfluidic devices, and which prolong the shelf life and allow more robust operation under different external conditions.

In some embodiments, the inventive device delivers drug-containing droplets or capsules which have an effective barrier than slowly breaks down in the body for timed release of the contents.

Field Diagnostics Systems:

A challenge for deploying hand-held lab-on-a-chip diagnostic systems in the field for automated detection of pathogens, disease markers, environmental monitoring and so on is the integration of control elements and the assay chemistries in the a single portable, low-power module. Most implementations employ external pumps and control elements to perform fluid control operations in the device. This leads to a cumbersome device reducing the portability of the device. Using integrated control and pumping, the technology described in this disclosure makes possible assembly of integrated diagnostics and analytical systems that can operate autonomously. The assay being performed is isolated from the pumping fluid, being encapsulated in a drop, bubble, vesicle, or solid capsule. Thus the device can be used to port many different assay chemistries without contamination. A portable lab-on-a-chip based on the inventive devices could be used in point-of-care diagnostics, personalized medicine, first response monitoring, health screening in developing countries, and early detection of chemical or biological threats. Examples include the early detection of signals of AIDS, tuberculosis, cancer or other diseases, differentiation between heart attack and stroke responses, analysis of genetic signals of exposure to toxic agents, screening for illegal drug use, or environment screening of drinking water.

Large-Scale Cellular Analysis:

Platforms to process and analyze a large number of cellular/sub-cellular components in a high throughput manner are required both in the field of conventional biology, tissue engineering and the emerging field of stem cell biology. Most platforms currently use wells that are static in nature, and programmable arbitrary manipulation is not possible. The cross junction trap/sort device depicted in FIG. 8 can be connected in a highly parallel manner allowing for high throughput cellular processing. Current platforms designed for such a task are unreliable and do not allow arbitrary sorting capability since bulk hydrodynamic forces are used for trapping and releasing individual cells.

The inventive devices can also be used to trap and observe multiple cells in single droplets or capsules to study their interactions in a carefully controlled chemical or biological environment. For example, this method could be used to study the growth and differentiation of embryonic stem cells in real time. Chemical stimuli can also be administered to the trapped cells from the outer fluid, via diffusion into the droplet. For example, this could be useful in the discovery of new enzymes or biomarkers.

Biofuel Processing.

The efficient formation of biofuels is often limited by the ability to control the local chemical environment of the active cells. In particular, the desired fuel product, such as alcohol or other energetic molecules, which is produced by a cell or bacterium, must be rapidly extracted from the vicinity of its source to keep the biological reaction proceeding at full pace and avoid surrounding it with the “waste”. The inventive devices could be used to trap single bacteria or clusters of biofuel-producing materials in droplets or permeable capsules, which are suspended or otherwise manipulated by nonlinear electrokinetic flows. A background pressure-driven or nonlinear electrokinetic flow could also be used to wash away the fuel product or bring more nutrients as needed to optimize the fuel production rate. As describe above, this could be done in a large-scale parallel device to enhance overall production.

Bio-Emulsion and Nanocapsule Fabrication.

Multiphase fluids can be used to store a variety of drugs, such as hormones suspended in oil/serum droplets in water. The inventive devices can be used to encapsulate biofluids in monodisperse droplets with optimized properties for long-term storage and with the ability to be counted in discrete nano-packages. The droplets can also contain single cells, which case the sample fluid could also contain a gel growth medium, initially diluted to reduce the viscosity and elasticity to allow flow, and then hardened or provided with nutrients by changing the chemistry of outer-phase fluid after microfluidic fabrication.

Shelf life of biomaterials stored in the sample fluid can be greatly enhanced, for example, by using the inventive devices to fabricate designer suspensions of “nanocapsules” with solid shells around the sample fluid droplets. For example, this can be done by using the inventive flow-focusing devices to create a double emulsion of the droplets containing the sample fluid surrounded by a UV sensitive monomer solution. Polymerization by UV light then forms a solid outer capsule for the inner-phase sample fluid and its constituents. Nonlinear electrokinetic flows could provide greater control over the double emulsion formation process, as well as accurate mixing, sorting and dispensing of the desired capsules or droplets with high throughput for processing large volumes. The nanocapsules could contain drugs, cells or biomaterials to achieve much longer shelf life and to better withstand extreme environments.

Nanomaterials Processing.

The inventive devices can be used to fabricate colloidal building blocks for designer materials with specially engineered optical, electrical, or mechanical properties. For example, the solidification of droplets, capsules, or droplet clusters can be used to make solid nanoparticles of precisely controlled size, shape, and composition. Nonlinear electrokinetic flows can be used to locally and precisely control the jet breakup process in flow focusing leading to initial droplet formation in single or double emulsions, prior to solidification. In some embodiments, the solidification step can be done rapidly in the device using UV light applied to a UV sensitive monomer solution in an inner or middle phase. In other embodiments, freezing or solvent evaporation can be used to solidify a melt or drive a sol-gel transition. The inventive devices can also be used to precisely sort, mix or concentrate the emulsion or eventual colloidal suspension with high throughtput in a microfluidic device.

Although the invention has been described in conjunction with specific embodiments thereof, it is evident that many alternatives, modifications and variations will be apparent to those skilled in the art, any of which are to be considered as part of this invention.

It will be understood by those skilled in the art that various changes in form and details may be made therein without departing from the spirit and scope of the invention as set forth in the appended claims. Those skilled in the art will recognize, or be able to ascertain using no more than routine experimentation, many equivalents to the specific embodiments of the invention described herein. Such equivalents are intended to be encompassed in the scope of the claims.

In the claims articles such as “a,”, “an” and “the” mean one or more than one unless indicated to the contrary or otherwise evident from the context. Claims or descriptions that include “or” or “and/or” between members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides, in various embodiments, all variations, combinations, and permutations in which one or more limitations, elements, clauses, descriptive terms, etc., from one or more of the listed claims is introduced into another claim dependent on the same base claim unless otherwise indicated or unless it would be evident to one of ordinary skill in the art that a contradiction or inconsistency would arise. Where elements are presented as lists, e.g. in Markush group format or the like, it is to be understood that each subgroup of the elements is also disclosed, and any element(s) can be removed from the group. It should it be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in haec verba herein. Certain claims are presented in dependent form for the sake of convenience, but Applicant reserves the right to rewrite any dependent claim in independent format to include the elements or limitations of the independent claim and any other claim(s) on which such claim depends, and such rewritten claim is to be considered equivalent in all respects to the dependent claim in whatever form it is in (either amended or unamended) prior to being rewritten in independent format.

1. A method for conducting or circulating a sample within an inner fluid phase dispersed in an outer fluid phase via non-linear electrokinetic flow, said method comprising:
applying at least one fluid to an electrokinetic device,
said electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
electro-osmotic flows with at least one varied trajectory in a region of said chamber, resulting in mixing of said electrolyte fluid;
a dominant electroosmotic flow which drives said electrolyte fluid across said chamber;
or a combination thereof;
said at least one fluid comprising:
a dispersion of a solid or fluid sample in an outer fluid phase, which outer fluid phase comprises an electrolyte fluid; or
a first fluid comprising an electrolyte and a second fluid comprising a sample, which second fluid is immiscible in said first fluid, and
applying an electric filed to said chamber in at least a single direction,
whereby upon the application of said electric field, said sample is conducted across said chamber or circulated in said chamber, or a combination thereof.

2. The method of claim 1, whereby upon application of an electric field to said chamber said sample in said second fluid is dispersed in said first fluid.

3. The method of claim 1, wherein operation of said nonlinear electrokinetic device provides for induced-charged electro-osmotic flow in said device.

4. The method of claim 1, wherein operation of said nonlinear electrokinetic device provides for alternating current electro-osmotic flow in said device.

5. The method of claim 1, wherein operation of said nonlinear electrokinetic device provides for alternating current electrothermal flow in said device.

6. The method of claim 1, wherein operation of said nonlinear electrokinetic device provides for dielectrophoresis in said device.

7. The method of claim 1, wherein said electric field is comprised of a DC electric field.

8. The method of claim 1, wherein said electric field is comprised of an AC or pulsed AC electric field.

9. The method of claim 1, wherein said chamber is comprised of a transparent material.

10. The method of claim 1, wherein said plurality of electrodes comprises at least one electrode, or a portion thereof, which is raised with respect to another electrode, or another portion of said at least one electrode.

11. The method of claim 1, wherein said plurality of electrodes comprises at least one electrode, or a portion thereof, which is lowered with respect to another electrode, or another portion of said at least one electrode.

12. The method of claim 1, wherein said plurality of electrodes comprises at least one electrode or at least a portion thereof having a height or depth, which is varied proportionally to a width of another electrode, another portion of said at least one electrode, or a combination thereof.

13. The method of claim 1, wherein said plurality of electrodes comprises at least one electrode, or portions thereof, having:
height or depth variations from about 1% to about 1000% of a width of another electrode, another portion of said at least one electrode, or a combination thereof;
a gap between said at least one electrode and another electrode;
or a combination thereof.

14. The method of claim 1, wherein said dispersion comprises an emulsion.

15. The method of claim 1, wherein said dispersion comprises a double emulsion.

16. The method of claim 1, wherein said dispersion comprises said sample contained within a drop or bubble suspended in said electrolyte fluid.

17. The method of claim 1, wherein said sample has a salt concentration of between about 1 μM-10M.

18. The method of claim 1, wherein said first fluid phase or outer fluid phase has a salt concentration of between about 0.01 mM-9 mM.

19. The method of claim 1, wherein said first fluid phase or outer fluid phase has a salt concentration of between about 0.1 μM-100 mM.

20. The method of claim 1, wherein the arrangement of said electrodes and selective application of at least one electric field applies shear stress to said second fluid, or said sample suspension in said electrolyte fluid.

21. The method of claim 1, wherein said device comprises at least two series of electrodes, which series can be modulated temporally in terms of the timing, strength, or oriented application of an electric field or a combination thereof.

22. The method of claim 1, wherein said method further comprises the step of specific sorting of said second fluid, or said sample suspension in said electrolyte fluid to a prescribed region of said chamber.

23. The method of claim 21, wherein said method further comprises the step of specific trapping of said second fluid, or said sample suspension in said electrolyte fluid within a prescribed region of said chamber.

24. The method of claim 1, wherein said method further comprises the step of specific trapping of said second fluid, or said sample suspension in said electrolyte fluid within a prescribed region of said chamber.

25. The method of claim 1, wherein said device is coupled to an analytical module.

26. A kit for conducting or circulating a sample within a separate inner fluid phase from that of an outer fluid phase via non-linear electrokinetic flow, said kit comprising:
at least one electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
electro-osmotic flows with at least one varied trajectory in a region of said chamber, resulting in mixing of said electrolyte fluid;
a dominant electroosmotic flow which drives said electrolyte fluid across said chamber; or
a combination thereof;
a dispersion of a solid or fluid sample in an outer fluid phase, which outer fluid phase comprises an electrolyte fluid; or
whereby upon the loading of said dispersion in said chamber and the application of an electric field to said chamber, said sample is conducted across said chamber or agitated in said chamber, or a combination thereof.

27. The kit of claim 26, wherein said dispersion comprises an emulsion.

28. The kit of claim 26, wherein said dispersion comprises a double emulsion.

29. The kit of claim 27, wherein said dispersion comprises said sample contained within a drop or bubble suspended in said electrolyte fluid.

30. A kit for conducting or circulating a sample within a separate inner fluid phase from that of an outer fluid phase via non-linear electrokinetic flow, said kit comprising:
at least one electrokinetic device comprising at least one microfluidic chamber for conducting an electrolyte fluid or circulating an electrolyte fluid, or a combination thereof, therein, said chamber comprising a plurality of electrodes proximal to, or positioned on, a surface of said chamber, wherein at least two of said plurality of electrodes are connected to a source providing an electric field in said chamber and said electrodes are arranged so as to produce:
electro-osmotic flows with at least one varied trajectory in a region of said chamber, resulting in mixing of said electrolyte fluid;
a dominant electroosmotic flow which drives said electrolyte fluid across said chamber; or
a combination thereof;
a first fluid comprising an electrolyte; and
a second fluid comprising a sample, which second fluid is immiscible in said first fluid;
whereby upon the loading of said first fluid and second fluid in said device and the application of an electric field to said chamber, said sample is conducted across said chamber or agitated in said chamber, or a combination thereof.

31. The kit of claim 30, whereby upon application of an electric field to said chamber said sample in said second fluid is dispersed in said first fluid.

32. The kit of claim 26 or 30, wherein operation of said nonlinear electrokinetic device provides for induced-charged electro-osmotic flow in said device.

33. The kit of claim 26 or 30, wherein operation of said nonlinear electrokinetic device provides for alternating current electro-osmotic flow in said device.

34. The kit of claim 26 or 30, wherein operation of said nonlinear electrokinetic device provides for alternating current electrothermal flow in said device.

35. The kit of claim 26 or 30, wherein operation of said nonlinear electrokinetic device provides for dielectrophoresis in said device.

36. The kit of claim 26 or 30, wherein said device accommodates an electric field comprised of a DC electric field.

37. The kit of claim 26 or 30, wherein said device accommodates an electric field comprised of an AC or pulsed AC electric field.

38. The kit of claim 26 or 30, wherein said chamber is comprised of a transparent material.

39. The kit of claim 26 or 30, wherein said plurality of electrodes comprises at least one electrode, or a portion thereof, which is raised with respect to another electrode, or another portion of said at least one electrode.

40. The kit of claim 26 or 30, wherein said plurality of electrodes comprises at least one electrode, or a portion thereof, which is lowered with respect to another electrode, or another portion of said at least one electrode.

41. The kit of claim 26 or 30, wherein said plurality of electrodes comprises at least one electrode or at least a portion thereof having a height or depth, which is varied proportionally to a width of another electrode, another portion of said at least one electrode, or a combination thereof.

42. The kit of claim 26 or 30, wherein said plurality of electrodes comprises at least one electrode, or portions thereof, having:
height or depth variations from about 1% to about 1000% of a width of another electrode, another portion of said at least one electrode, or a combination thereof;
a gap between said at least one electrode and another electrode;
or a combination thereof.

43. The kit of claim 26 or 30, wherein said sample has a salt concentration of between about 1 μM-10M.

44. The kit of claim 26 or 30, wherein said first fluid phase or outer fluid phase has a salt concentration of between about 0.01 mM-9 mM.

45. The kit of claim 26 or 30, wherein said first fluid phase or outer fluid phase has a salt concentration of between about 0.1 μM-100 mM.

46-109. (canceled)
